(19) United States
(12) Patent Application Publication
(10) Pub. No.: US 2026/0196611 A1
(43) Pub. Date: Jul. 9, 2026

(54) SECONDARY BATTERY AND BATTERY PACK INCLUDING THE SAME

(71) Applicant: SAMSUNG SDI CO., LTD., Yongin-si (KR)

(72) Inventor: Ji Won YUN, Suwon-si (KR)

(21) Appl. No.: 19/440,049

(22) Filed: Jan. 5, 2026

(30) Foreign Application Priority Data
Jan. 3, 2025 (KR) 10-2025-0000994
May 7, 2025 (KR) 10-2025-0058900

(51) Int. Cl. H01M 50/107; H01M 50/121; H01M 50/124; H01M 50/133; H01M 50/167; H01M 50/184; H01M 50/186; H01M 50/213

(52) U.S. Cl. CPC H01M 50/107; H01M 50/121; H01M 50/124; H01M 50/133; H01M 50/167; H01M 50/184; H01M 50/186; H01M 50/213

(57) ABSTRACT

A secondary battery and a battery pack including the same are disclosed. A secondary battery includes a case including an opening, an electrode assembly accommodated in the case, and a cap assembly facing the opening, and the case includes a crimping part that surrounds the cap assembly and includes an exposure prevention part to prevent exposure of an end part of the crimping part.

### CROSS-REFERENCE TO RELATED APPLICATIONS

The present application claims priority to and the benefit of Korean Patent Application No. 10-2025-0000994, filed on Jan. 3, 2025 in the Korean Intellectual Property Office, and Korean Patent Application No 10-2025-0058900, filed on May 7, 2025 in the Korean Intellectual Property Office, the entire disclosures of both of which are incorporated herein by reference.

### BACKGROUND

### 1. Field

Aspects of embodiments of the present disclosure relate to a secondary battery and a battery pack including the same.

### 2. Description of the Related Art

In general, recently, with the rapid spread of electronic devices that use batteries, such as mobile phones, laptop computers, and electric vehicles, the demand for rechargeable batteries with high energy density and high capacity is rapidly increasing. Accordingly, research and development to improve the performance of rechargeable lithium batteries is actively underway.

A rechargeable lithium battery is a battery including a positive electrode and a negative electrode, which include active materials that enable intercalation and deintercalation of lithium ions, and an electrolyte, and produces electrical energy through oxidation and reduction when lithium ions are intercalated/deintercalated into/from the positive and negative electrodes.

The above-described information disclosed in the background technology of the present invention is provided to facilitate understanding of the background of the present invention and may include information that does not constitute the related art.

### SUMMARY

According to an aspect of embodiments of the present disclosure, a secondary battery and a battery pack including the same, which are capable of preventing (preventing or substantially preventing) a case from being damaged are provided.

According to another aspect of embodiments of the present disclosure, a secondary battery and a battery pack including the same, which are capable of improving sealing performance and preventing (preventing or substantially preventing) leakage are provided.

However, aspects and technical problems to be solved by the present invention are not limited to the aspects and problems to be solved described above, and other aspects and problems to be solved not mentioned can be clearly understood by those of ordinary skill in the art from the description of the present invention described below.

According to one or more embodiments of the present disclosure, a secondary battery includes a case including an opening, an electrode assembly accommodated in the case, and a cap assembly facing the opening, wherein the case includes a crimping part that surrounds the cap assembly and includes an exposure prevention part to prevent exposure of an end part of the crimping part.

In one or more embodiments, the exposure prevention part may be configured such that the end part of the crimping part is bent toward the inside of the case. For example, the exposure prevention part may have a shape in which the end part of the crimping part is bent toward the inside of the case one or more times to overlap.

In one or more embodiments, the secondary battery may further include a gasket arranged between the cap assembly and the crimping part and sealing the case, and the exposure prevention part may be inclined downward into the case so as to press the gasket.

In one or more embodiments, the end part of the crimping part may be thinner than a thickness of the crimping part.

In one or more embodiments, the end part of the crimping part may have a thickness that is 50% or less of the thickness of the crimping part.

In one or more embodiments, a length of the end part of the crimping part may be 3 to 5 mm from an end of the crimping part.

In one or more embodiments, the secondary battery may further include a gasket arranged between the cap assembly and the crimping part and sealing the case, wherein the gasket may include a sealing part sealing a space between the gasket and the exposure prevention part.

In one or more embodiments, the sealing part may include a protrusion (e.g., a close contact protrusion) protruding from the gasket to come into contact (e.g., close contact) with a bottom surface of the exposure prevention part.

In one or more embodiments, the sealing part may include an accommodation groove included in the gasket and accommodating the exposure prevention part.

In one or more embodiments, the accommodation groove may include a protrusion (e.g., a close contact protrusion) protruding from the gasket to come into contact (e.g., close contact) with the bottom surface of the exposure prevention part.

In one or more embodiments, the exposure prevention part may be inclined downward into the case, and the accommodation groove may include an accommodation inclined surface contacting the bottom surface of the exposure prevention part; and an accommodation vertical surface extending vertically from an end of the accommodation inclined surface.

In one or more embodiments, the exposure prevention part may be configured such that the end part of the crimping part is wound into a roll shape.

In one or more embodiments, the gasket may include an accommodation groove accommodating a part of the exposure prevention part, and the accommodation groove may have a semicircular shape.

In one or more embodiments, the exposure prevention part may be configured such that the end part of the crimping part is coated with a resin.

In one or more embodiments, the exposure prevention part may be configured such that the end part of the crimping part is folded one or more times inside the case to overlap.

According to one or more embodiments of the present disclosure, a secondary battery may include an electrode assembly; and a case accommodating the electrode assembly and including a sidewall part, a bottom part closing a first end of the sidewall part, and an opening at a second end of the sidewall part. The sidewall part may include a first region including a beading part arranged concavely toward an inside and having a first thickness, and a second region located adjacent to a second end and having a second thickness smaller than the first thickness.

In one or more embodiments, the sidewall part may include a bent part at a location where the beading part begins, and a boundary between the first region and the second region may be located between the bent part and the second end of the sidewall part.

In one or more embodiments, a boundary between the first region and the second region may include the bent part.

In one or more embodiments, the sidewall part may include a crimping part formed by bending the second end of the sidewall part toward an inside of the case, and the second region may include the crimping part.

In one or more embodiments, the boundary between the first region and the second region may be located where the bending of the crimping part begins.

In one or more embodiments, the second thickness may be 25% to 65% of the first thickness.

In one or more embodiments, the second thickness may be from 0.0625 to 0.1625 mm.

In one or more embodiments, the second region may have a uniform second thickness as a whole.

In one or more embodiments, the second region may become thinner toward the second end of the sidewall part from a boundary with the first region.

In one or more embodiments, the second region may include a first portion adjacent to the first region and having a third thickness; and a second portion adjacent to the second end and having a fourth thickness smaller than the third thickness.

In one or more embodiments, the second portion may extend from the first portion with a step.

In one or more embodiments, the second region may further include a third portion having a fifth thickness smaller than the third thickness and larger than the fourth thickness, and the third portion may be located between the first portion and the second portion, and have a step with at least one of the first portion and the second portion.

In one or more embodiments, the second region may extend from the first region in a curved manner.

In one or more embodiments, the second region may extend from the first region with a step.

In one or more embodiments, the secondary battery may further include a cap assembly joined to the opening of the case to seal the case; and a gasket arranged between the case and the cap assembly and including an insulating material.

In one or more embodiments, the other end of the sidewall part may be bent toward an inside of the case to come into contact with the gasket.

In one or more embodiments, the second end of the sidewall part may press a point of the gasket while compressing the point.

In one or more embodiments, a compression rate of the point of the gasket may be 30% or more.

In one or more embodiments, the second region may be formed through a forging process.

According to one or more embodiments of the present disclosure, a battery pack may include a housing; a plurality of secondary batteries accommodated in the housing; and a bus bar connecting the plurality of secondary batteries. Each of the secondary batteries may include a case including an opening, an electrode assembly accommodated in the case, and a cap assembly facing the opening, wherein the case may include a crimping part that surrounds the cap assembly and includes an exposure prevention part to prevent exposure of an end part.

According to an aspect of embodiments of the present disclosure, sealing performance between the crimping part and the gasket can be enhanced, thereby preventing or substantially preventing leakage and improving sealing reliability. In addition, as the exposure prevention part is formed at an end part of the crimping part, exposure of a trimming part to the outside can be prevented or substantially prevented, thereby preventing or substantially preventing damage to the case and maintaining case strength. In addition, a sealing part that can improve sealing with the exposure prevention part can be formed in the gasket, resulting in improved sealing reliability.

However, aspects and effects that can be obtained by the present invention are not limited to the aspects and effects mentioned above, and other aspects and technical effects not mentioned herein will be clearly understood by those of ordinary skill in the art from the following description of the present invention.

### BRIEF DESCRIPTION OF THE DRAWINGS

The following drawings included with the present specification are provided to illustrate some embodiments of the present invention, and the spirit of the present invention will be more clearly understood from the accompanying drawings together with the following description of the invention; however, the present invention is not to be construed as being limited to matters described in such drawings, in which:

FIG. 1 is a perspective view schematically illustrating a configuration of a battery pack according to an embodiment of the present disclosure;

FIG. 2 is a perspective view schematically illustrating a configuration of a secondary battery according to an embodiment of the present disclosure;

FIG. 3 is a cross-sectional view schematically illustrating the configuration of the secondary battery of FIG. 2;

FIG. 4 is an enlarged view schematically illustrating a configuration of a cap assembly according to an embodiment of the present disclosure;

FIG. 5 is a view schematically illustrating a configuration of an exposure prevention part according to an embodiment of the present disclosure;

FIG. 6 is a view schematically illustrating a process of forming the exposure prevention part according to an embodiment of the present disclosure;

FIG. 7 is another example schematically illustrating the configuration of the exposure prevention part according to an embodiment of the present disclosure;

FIG. 8 is a view schematically illustrating a process of forming the example of the exposure prevention part of FIG. 7;

FIG. 9 is a view schematically illustrating a configuration of an exposure prevention part according to another embodiment of the present disclosure;

FIGS. 10 to 12 are views schematically illustrating other examples of sealing parts according to embodiments of the present disclosure;

FIG. 13 is a view schematically illustrating a configuration of an exposure prevention part according to another embodiment of the present disclosure;

FIG. 14 is a view schematically illustrating a process of forming the exposure prevention part of FIG. 13;

FIG. 15 is a view schematically illustrating a configuration of an exposure prevention part according to another embodiment of the present disclosure;

FIG. 16 is a view schematically illustrating a process of forming the exposure prevention part of FIG. 15;

FIG. 17 is a view schematically illustrating another example of the exposure prevention part according to an embodiment of the present disclosure;

FIG. 18 is a cross-sectional view schematically illustrating a secondary battery according to another embodiment of the present disclosure;

FIG. 19 is a view illustrating an example of a sidewall part of a case of the secondary battery of FIG. 18;

FIG. 20 is a view illustrating another example of a sidewall part of a case of the secondary battery of FIG. 18;

FIG. 21 is a view illustrating another example of a sidewall part of a case of the secondary battery of FIG. 18;

FIG. 22 is a cross-sectional view illustrating an example of an upper portion of a case of the secondary battery of FIG. 18;

FIG. 23 is an example of an enlarged view of a region “M” of FIG. 22;

FIG. 24 is another example of an enlarged view of the region “M” of FIG. 22;

FIG. 25 is a view illustrating an example of a method of manufacturing a secondary battery according to an embodiment of the present disclosure;

FIG. 26 is a view illustrating an example of a method of manufacturing a secondary battery according to an embodiment of the present disclosure; and

FIG. 27 is a view illustrating an example of a method of manufacturing a secondary battery according to an embodiment of the present disclosure.

### DETAILED DESCRIPTION

Herein, some example embodiments of the present invention will be described in further detail with reference to the accompanying drawings. However, terms and words used in the specification and claims are not to be construed as limited to general or dictionary meanings, and are to be interpreted as having meanings and concepts in accordance with the technical idea of the present invention based on the principle that the inventors have appropriately defined the concepts of terms in order to explain the invention in the best way. Therefore, since the configurations of the examples described herein are provided as some example embodiments and do not necessarily represent all of the technical spirit of the present invention, it is to be understood that there may be various equivalents and modifications that can replace the examples at the time of the application. The terms used in the specification are used to explain some examples, and the present invention is not limited thereto. As used in the specification, a singular form may include a plural form unless clearly indicated otherwise in the context. In addition, “comprise/include” and/or “comprising/including” used herein specifies the presence of cited shapes, numbers, steps, actions, members, elements and/or a group thereof, and does not exclude the presence or addition of one or more shapes, numbers, actions, members, elements and/or groups. In addition, when describing embodiments of the present invention, “capable of” or “may” may include “one or more embodiments of the present invention.”

In addition, to facilitate understanding of the present invention, the drawings may not necessarily be drawn to actual scale, and some components may be shown with exaggerated dimensions. In addition, the same reference numerals may be assigned to the same components in different embodiments.

The mention that two comparative objects are “identical” or “the same” means substantially identical or substantially the same. Thus, “identical,” “the same,” “substantial identical,” or “substantially the same” may include cases having deviations considered low in the art, for example, deviations within 5%. In addition, uniformity of any parameter in a given region may mean uniformity from an average perspective.

Although “first,” “second,” and the like are used to describe various components, it is to be understood that these components are not limited by these terms. These terms are used to distinguish one component from another, and, therefore, unless otherwise specifically stated, the first component may also be the second component.

Throughout the specification, unless otherwise specifically stated, each component may be singular or plural.

Any configuration being disposed “upper (or beneath)” of a component or “on (or under)” a component may mean not only that this configuration is disposed in contact with the top (or bottom) surface of the component, but also that another configuration may be interposed between the component and any configuration disposed on top (or bottom) of the component.

In addition, when a component is described as being “coupled,” “joined” or “connected” to another component, it is to be understood that the components may be directly coupled or connected to each other, but also that a third component may be “interposed” between the components, or the components may be “coupled,” “joined” or “connected” to each other by a third component. In addition, when a part is said to be electrically coupled to another part, this includes not only cases in which the parts are directly coupled, but also cases in which the parts are coupled via another element interposed therebetween.

Throughout the specification, when “A and/or B” is used, it means A, B, or both A and B, unless specifically stated otherwise. That is, “and/or” includes any and all combinations of the listed plurality of items. When “C to D” is said, it means C or more and D or less, unless specifically stated otherwise.

When phrases such as “at least one of A, B, and C,” “at least one of A, B, or C,” “at least one selected from the group consisting of A, B, and C.” or “at least one selected from A, B, and C” are used to specify a list of elements A, B, and C, the phrases may refer to any and all suitable combinations of the elements.

The term “use” may be regarded as synonymous with the term “utilize.” As used herein, the terms “substantially,” “approximately” and similar terms are used as terms of approximation and not as terms of degree, and are intended to account for inherent variations in measured or calculated values as recognized by those of ordinary skill in the art.

It is to be understood that, in the specification, terms such as “first,” “second,” and “third” may be used to describe various elements, components, regions, layers, and/or sections, but the elements, components, regions, layers, and/or sections are not to be limited by these terms. The terms are used to distinguish one element, component, region, drawing layer, or cross-section from another element, component, region, drawing layer, or cross-section. Therefore, a first element, component, region, layer, or section discussed below may be termed a second element, component, region, layer, or section without departing from the teachings of the example embodiments.

As shown in the drawings, spatially relative terms, such as “beneath,” “below,” “lower,” “above,” “upper,” and the like, may be used herein for ease of description to describe the relationship of one element or feature to another element(s) or feature(s). It is to be understood that the spatially relative positions are intended to encompass different orientations of the device in use or operation, in addition to the directions depicted in the drawings. For example, if a device in the drawing is turned over, an element described as “below” or “beneath” another element would then be understood as “upper” or “above” the other element. Accordingly, the term “below” may encompass all directions such as upper and below.

The terminology used herein is for describing embodiments of the present disclosure and is not intended to limit the present disclosure.

Herein, referring to the accompanying drawings, secondary batteries and battery packs including the same according to various embodiments of the present disclosure will be described. In this process, the thickness of lines and the sizes of components shown in the drawings may be exaggerated for clarity and convenience of explanation. In addition, the terms described below are terms defined in consideration of the functions in the present invention, and may vary depending on the intention or custom of the user or operator. Therefore, definitions of these terms should be based on the context throughout this specification.

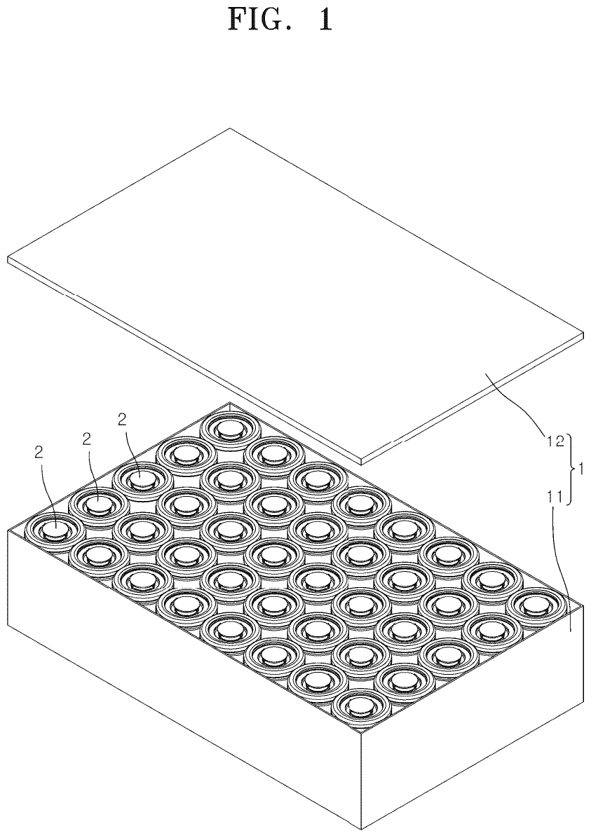

FIG. 1 is a perspective view schematically illustrating a configuration of a battery pack according to an embodiment of the present disclosure. Referring to FIG. 1, a battery pack includes a housing 1, and a secondary battery 2.

The housing 1 may form a general exterior of the battery pack, and provide a space for accommodating the secondary battery 2. The housing 1 may include a housing body 11 and a cover 12.

The housing body 11 may be formed to have a box shape with an empty interior and an open side. However, a cross-sectional shape of the housing body 11 is not limited to a rectangular shape, as shown in FIG. 1, and may be varied to have any of various shapes, such as polygonal, circular, oval shapes, and the like.

The cover 12 may be joined to the housing body 11 and close an internal space of the housing body 11. As an example, the cover 12 may be formed generally in a plate shape and disposed to face the open side of the housing body 11. The cover 12 may be fixed to the housing body 11 by any of various types of joining methods, such as any of bolting, welding, and fitting.

The secondary battery 2 may function as a unit structure that stores and supplies power in the battery pack.

In an embodiment, a plurality of secondary batteries 2 may be provided. The plurality of secondary batteries 2 may be disposed in the housing 1 in any of various patterns, such as grid, zigzag configurations, and the like. The plurality of secondary batteries 2 may be disposed in parallel. The number of secondary batteries 2 can be varied depending on a size and shape of the housing 1, for example. A further detailed configuration of the secondary batteries 2 will be described below.

The plurality of secondary batteries 2 may be electrically coupled by a bus bar (not shown). The plurality of secondary batteries 2 may be connected in series or parallel by a bus bar. As an example, a bus bar may connect secondary batteries 2 disposed in a same row in the housing 1 in parallel, and secondary batteries 2 disposed in two adjacent rows in series. The bus bar may be formed of an electrically conductive material, such as copper, aluminum, or nickel.

Herein, configurations of secondary batteries according to various embodiments of the present disclosure will be described.

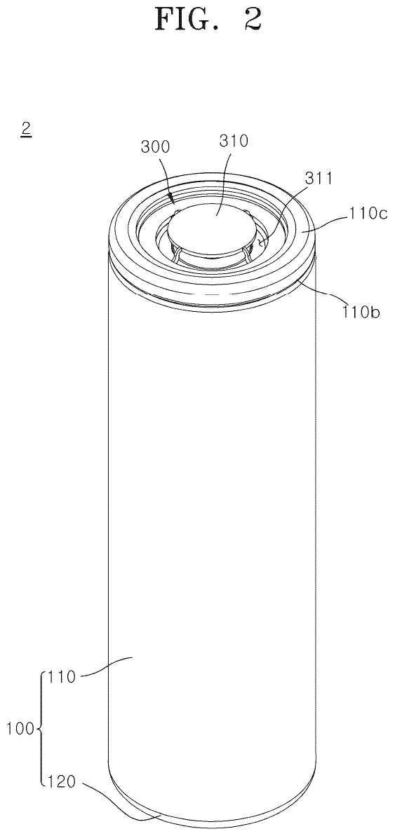

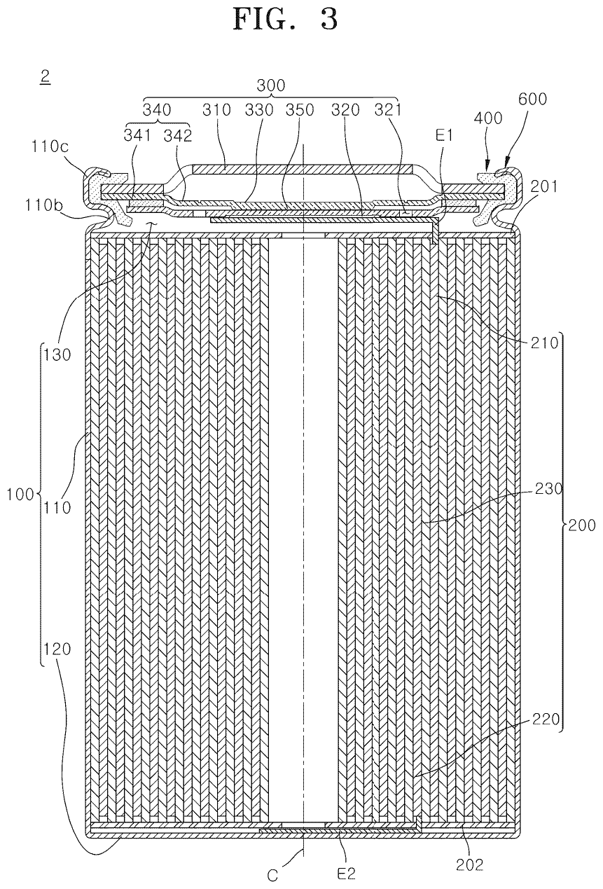

FIG. 2 is a perspective view schematically illustrating a configuration of a secondary battery according to an embodiment of the present disclosure; and FIG. 3 is a cross-sectional view schematically illustrating the configuration of the secondary battery of FIG. 2. Referring to FIGS. 2 and 3, the secondary battery 2 may include a case 100, an electrode assembly 200, a cap assembly 300, a crimping part, a gasket, and an exposure prevention part.

An example in which the secondary battery 2 is a cylindrical lithium-ion secondary battery will be described below. However, the present disclosure is not limited thereto, and the secondary battery 2 may be a lithium polymer battery or a prismatic battery, for example.

The case 100 may form a general exterior of the secondary battery 2. In an embodiment, the case 100 may be provided to be electrically conductive. For example, the case 100 may include at least one or more materials among steel, stainless steel, aluminum, and an aluminum alloy. Therefore, the case 100 may protect the electrode assembly 200 from external impacts, and have a heat dissipation function for dissipating heat accompanying charging/discharging operations of the electrode assembly 200 to the outside.

The case 100 may include a cylindrical sidewall part 110 with a central axis C in the center. The central axis C of the case 100 described below may refer to the central axis of the sidewall part 110. Both, or opposite, ends of the sidewall part 110 perpendicular to the central axis C of the case 100 may be formed to be open. The sidewall part 110 may further include a beading part 110b and a crimping part 110c, which will be described below.

The case 100 may further include a bottom part 120 closing a lower part of the sidewall part 110. The bottom part 120 may be formed to have a generally circular shape, and disposed to face the lower part of the sidewall part 110. The bottom part 120 may be disposed perpendicular to the central axis C of the case 100. A circumferential surface of the bottom part 120 may be joined to the lower part of the sidewall part 110. In an embodiment, the bottom part 120 may be integrally formed with the sidewall part 110 through a drawing process. In an embodiment, the bottom part 120 may be separately manufactured from the sidewall part 110 and then joined thereto by welding.

The case 100 may further include an opening 130 included at the upper part of the sidewall part 110. The opening 130 may provide a path through which an electrode assembly 200 to be described below is inserted into the case 100 from a region above the case 100 and provide a space where the cap assembly 300 is installed or accommodated. The opening 130 according to an embodiment may refer to an empty space surrounded by the upper part of the sidewall part 110 located on the opposite side of the bottom part 120.

The electrode assembly 200 may function as a unit structure that performs charging and discharging operations of power in the secondary battery 2. The electrode assembly 200 may include a first electrode plate 210, a second electrode plate 220, and a separator 230 disposed between the first electrode plate 210 and the second electrode plate 220.

The electrode assembly 200 may be disposed in the case 100. The electrode assembly 200 may be inserted into the case 100 through the opening 130 of the case 100.

The electrode assembly 200 may have a form in which the electrode assembly 200 is wound around a winding axis. The electrode assembly 200 may be configured to be wound clockwise or counterclockwise around the winding axis while the first electrode plate 210, the separator 230, and the second electrode plate 220 are stacked. Accordingly, the electrode assembly 200 may generally have a jelly roll shape. A cross-sectional shape of the electrode assembly 200 may have any of various shapes, such as oval and polygonal shapes, in addition to a circular shape. Here, the winding axis may refer to a straight line passing through the center of the electrode assembly 200. The winding axis of the electrode assembly 200 may be coaxial with the central axis C of the case 100.

In an embodiment, the first electrode plate 210 may function as a positive electrode of the electrode assembly 200. The first electrode plate 210 may have a form of a foil including a metal material, such as aluminum or an aluminum alloy. A type, size and shape of the first electrode plate 210 are not particularly limited as long as the first electrode plate 210 has conductivity without causing chemical changes in the secondary battery.

A first active material layer may be applied to at least a part of the first electrode plate 210. In an embodiment, the first active material layer may be applied to both, or opposite, surfaces of the first electrode plate 210. In an embodiment, the first active material layer may be applied to only one surface of the first electrode plate 210. In an embodiment, the first electrode plate 210 functions as a positive electrode, and the first active material layer may include a positive electrode active material.

The positive electrode active material may be a compound that enables reversible intercalation and deintercalation of lithium (lithiated intercalation compound). In an embodiment, as the positive electrode active material, one or more of composite oxides of lithium and a metal selected from cobalt, manganese, nickel, iron, and combinations thereof may be used.

As an example, the positive electrode active material may include at least one of lithium-iron-phosphorus oxide (LiFePO₄, LFP), lithium-manganese-iron-phosphorus oxide (LiMnFePO₄, LMFP), and lithium-nickel-cobalt-manganese oxide (LiNiₓCo_{y}Mn_{z}O₂, LNCM). Here, 0<x<1, 0<y<1, 0<z<1, and x+y+z=1 may be satisfied. The positive electrode active material may include only one of lithium-iron-phosphorus oxide (LiFePO₄, LFP), lithium-manganese-iron-phosphorus oxide (LiMnFePO₄, LMFP), and lithium-nickel-cobalt-manganese oxide (LiNiₓCo_{y}Mn_{z}O₂, LNCM), or may include two or all of lithium-iron-phosphorus oxide (LiFePO₄, LFP), lithium-manganese-iron-phosphorus oxide (LiMnFePO₄, LMFP), and lithium-nickel-cobalt-manganese oxide (LiNiₓCo_{y}Mn_{z}O₂, LNCM).

The first active material layer may further include a positive electrode conductive material. The positive electrode conductive material imparts conductivity to the first active material layer, and any suitable material that is electrically conductive and does not cause chemical changes may be used. Examples of the positive electrode conductive materials include carbon-based materials, such as natural graphite, artificial graphite, carbon black, acetylene black, Ketjen black, carbon fibers, carbon and nanofibers; metal-based materials in the form of a metal powder or metal fiber containing copper, nickel, aluminum, silver, and the like; conductive polymers, such as polyphenylene derivatives; or mixtures thereof.

The first active material layer may further include a positive electrode binder. The positive electrode binder may adhere particles constituting the positive electrode active material well and adhere the positive electrode active material to the first electrode plate 210 well. Examples of the positive electrode binder may include a non-aqueous binder, an aqueous binder, a dry binder, or a combination thereof.

The non-aqueous binder may be polyvinyl chloride, carboxylated polyvinyl chloride, polyvinyl fluoride, ethylene propylene copolymers, polystyrene, polyurethane, polytetrafluoroethylene, polyvinylidene fluoride (PVDF), polyethylene, polypropylene, polyamideimide, polyimide, or a combination thereof.

The aqueous binder may be selected from styrene-butadiene rubber, (meth)acrylated styrene-butadiene rubber, (meth)acrylonitrile-butadiene rubber, (meth)acryl rubber, butyl rubber, a fluoroelastomer, polyethylene oxide, polyvinylpyrrolidone, polyepichlorohydrin, polyphosphazene, poly(meth)acrylonitrile, ethylene-propylene-diene copolymers, polyvinylpyridine, chlorosulfonated polyethylene, latex, polyester resin, (meth)acrylic resin, phenolic resin, epoxy resin, polyvinyl alcohol, and combinations thereof.

If the aqueous binder is used as the positive electrode binder, a cellulose-based compound capable of imparting viscosity may be further included. As the cellulose-based compound, one or more of carboxymethyl cellulose, hydroxypropylmethyl cellulose, methyl cellulose, and alkali metal salts thereof may be mixed and used. In an embodiment, the alkali metal may be Na, K, or Li.

The dry binder is a polymer material capable of being fiberized, and may be, for example, polytetrafluoroethylene, PVDF, a polyvinylidene fluoride-hexafluoropropylene copolymer, polyethylene oxide, or a combination thereof.

The first electrode plate 210 may be electrically coupled to the cap assembly 300 described below. In an embodiment, the first electrode plate 210 functions as a positive electrode of the electrode assembly 200, and the cap assembly 300 may function as a positive electrode terminal of the secondary battery 2. As an example, the first electrode plate 210 may be electrically coupled to the cap assembly 300 by a first electrode tab E1. The first electrode tab E1 may include a conductive metal material, such as copper, a copper alloy, nickel, or a nickel alloy. The first electrode tab E1 may be disposed at the top of the electrode assembly 200, and both, or opposite, ends thereof may be connected to the first electrode plate 210 and the cap assembly 300, respectively. An end of the first electrode tab E1 may be directly connected to the first electrode plate 210, or may be indirectly connected to the first electrode plate 210 by a separate current collector plate (not shown) connected to the first electrode plate 210. However, the first electrode plate 210 is not limited thereto, and, in an embodiment, may be directly connected to the cap assembly 300 without the first electrode tab E1.

In an embodiment, the second electrode plate 220 may function as a negative electrode of the electrode assembly 200. The second electrode plate 220 may be formed to have a form of a foil including a metal material, such as copper, a copper alloy, nickel, or a nickel alloy. The second electrode plate 220 may be disposed to face the first electrode plate 210 at a distance (e.g., a predetermined distance).

A type, size, and shape of the second electrode plate 220 are not particularly limited as long as the second electrode plate 220 has conductivity without causing chemical changes in the secondary battery.

A second active material layer may be applied to at least a part of the second electrode plate 220. In an embodiment, the second active material layer may be applied to both, or opposite, surfaces of the second electrode plate 220. In an embodiment, the second active material layer may be applied to only one surface of the second electrode plate 220. In an embodiment, the second electrode plate 220 functions as a negative electrode, and the second active material layer may include a negative electrode active material.

The negative electrode active material includes a material capable of reversibly intercalating/deintercalating lithium ions, lithium metal, an alloy of lithium and a metal, a material capable of doping and dedoping lithium, or a transition metal oxide.

The material capable of reversibly intercalating/deintercalating lithium ions may be a carbon-based negative electrode active material, such as crystalline carbon, amorphous carbon, or a combination thereof. Examples of crystalline carbon may include graphite, such as amorphous, plate-like, flaky, spherical, or fibrous natural graphite or artificial graphite, and examples of amorphous carbon may include soft or hard carbon, mesophase pitch carbide, or calcined coke.

In an embodiment, the alloy of lithium and a metal may be an alloy of lithium and any metal selected from Na, K, Rb, Cs, Fr, Be, Mg, Ca, Sr, Si, Sb, Pb, In, Zn, Ba, Ra, Ge, Al, and Sn.

The material capable of doping and dedoping lithium may be a Si-based negative electrode active material or an Sn-based negative electrode active material. The Si-based negative electrode active material may be silicon, a silicon-carbon composite, SiOₓ (0<x≤2), a Si-Q alloy (Q is selected from alkali metals, alkaline earth metals, group 13 elements, group 14 elements (except Si), group 15 elements, group 16 elements, transition metals, rare earth elements, and combinations thereof), or a combination thereof. The Sn-based negative electrode active material may be Sn, SnO₂, an Sn-based alloy, or a combination thereof.

The silicon-carbon composite may be a composite of silicon and amorphous carbon. According to an embodiment, the silicon-carbon composite may be in the form of silicon particles of which surfaces are coated with amorphous carbon. For example, the silicon-carbon composite may include a secondary particle (core) in which primary silicon particles are assembled, and an amorphous carbon coating layer (shell) located on the surface of the secondary particle. The amorphous carbon is also located between the primary silicon particles, and the primary silicon particle may be coated with, for example, amorphous carbon. The secondary particles may be dispersed in an amorphous carbon matrix.

The silicon-carbon composite may further include crystalline carbon. For example, the silicon-carbon composite may include a core including crystalline carbon and silicon particles, and an amorphous carbon coating layer located on the core surface.

The silicon-based negative electrode active material or the Sn-based negative electrode active material may be used in combination with a carbon-based negative electrode active material.

The second active material layer may further include a negative electrode conductive material, and a negative electrode binder.

The negative electrode conductive material imparts conductivity to the second active material layer, and any suitable material that is electrically conductive and does not cause chemical changes may be used. Examples of the negative electrode conductive materials may include carbon-based materials, such as natural graphite, artificial graphite, carbon black, acetylene black, Ketjen black, carbon fibers, carbon and nanofibers; metal-based materials in the form of a metal powder or metal fiber containing copper, nickel, aluminum, silver, and the like; conductive polymers, such as polyphenylene derivatives; or mixtures thereof.

The negative electrode binder may adhere particles constituting the negative electrode active material well, and adhere the positive electrode active material to the second electrode plate 220 well. Examples of the negative electrode binder may include a non-aqueous binder, an aqueous binder, a dry binder, or a combination thereof.

The non-aqueous binder may be polyvinyl chloride, carboxylated polyvinyl chloride, polyvinyl fluoride, ethylene propylene copolymers, polystyrene, polyurethane, polytetrafluoroethylene, PVDF, polyethylene, polypropylene, polyamideimide, polyimide, or a combination thereof.

The aqueous binder may be selected from styrene-butadiene rubber, (meth)acrylated styrene-butadiene rubber, (meth)acrylonitrile-butadiene rubber, (meth)acryl rubber, butyl rubber, fluoroelastomer, polyethylene oxide, polyvinylpyrrolidone, polyepichlorohydrin, polyphosphazene, poly(meth)acrylonitrile, ethylene-propylene-diene copolymers, polyvinylpyridine, chlorosulfonated polyethylene, latex, polyester resin, (meth)acrylic resin, phenolic resin, epoxy resin, polyvinyl alcohol, and combinations thereof.

If the aqueous binder is used as the negative electrode binder, a cellulose-based compound capable of imparting viscosity may be further included. As the cellulose-based compound, one or more of carboxymethyl cellulose, hydroxypropylmethyl cellulose, methyl cellulose, and alkali metal salts thereof may be mixed and used. In an embodiment, the alkali metal may be Na, K, or Li.

The dry binder is a polymer material capable of being fiberized, and may be, for example, polytetrafluoroethylene, PVDF, a polyvinylidene fluoride-hexafluoropropylene copolymer, polyethylene oxide, or a combination thereof.

In an embodiment, the second electrode plate 220 may be electrically coupled to the case 100. As an example, the second electrode plate 220 may be electrically coupled to the case 100 by a second electrode tab E2. In an embodiment, the second electrode plate 220 functions as a negative electrode of the electrode assembly 200, and the case 100 may function as a negative electrode terminal of the secondary battery 2. The second electrode tab E2 may include a conductive metal material, such as copper, a copper alloy, nickel, or a nickel alloy. The second electrode tab E2 may be disposed at the bottom of the electrode assembly 200, and both, or opposite, ends thereof may be connected to the second electrode plate 220 and the bottom part 120 of the case 100, respectively. An end of the second electrode tab E2 may be directly connected to the second electrode plate 220, or may be indirectly connected to the second electrode plate 220 by a separate current collector plate (not shown) connected to the second electrode plate 220. However, the second electrode plate 220 is not limited thereto, and, in an embodiment, may be directly connected to the case 100 without a second electrode tab E2.

The separator 230 may be disposed between the first electrode plate 210 and the second electrode plate 220. The separator 230 may prevent or substantially prevent a short circuit between the first electrode plate 210 and the second electrode plate 220 while allowing the movement of lithium ions therebetween.

As the separator 230, polyethylene, polypropylene, polyvinylidene fluoride, or a multilayer of two or more thereof may be used, or a mixed multilayer, such as a polyethylene/polypropylene two-layer separator, a polyethylene/polypropylene/polyethylene three-layer separator, or a polypropylene/polyethylene/polypropylene three-layer separator may be used.

The separator 230 may include a porous substrate and a coating layer including an organic material, an inorganic material, or a combination thereof, which is located on one or both, or opposite, surfaces of the porous substrate.

The porous substrate may be a substrate with multiple pores that is conventionally used in an electrochemical device. The porous substrate may be, but is not limited to, a polymer film formed of any polymer selected from the group consisting of polyolefins such as polyethylene, polypropylene, etc., polyesters such as polyethylene terephthalate, polybutylene terephthalate, etc., polyacetal, polyamide, polyimide, polycarbonate, polyetheretherketone, polyaryletherketone, polyetherimide, polyamideimide, polybenzimidazole, polyethersulfone, polyphenylene oxide, a cyclic olefin copolymer, polyphenylene sulfide, polyethyelene naphthalate, glass fibers, and polytetrafluoroethylene (e.g., Teflon), or a copolymer or mixture of two or more thereof.

The organic material may include a polyvinylidene fluoride-based polymer or a (meth)acrylic polymer.

The inorganic material may contain inorganic particles selected from Al₂O₃, SiO₂, TiO₂, SnO₂, CeO₂, MgO, NiO, CaO, GaO, ZnO, ZrO₂, Y₂O₃, SrTiO₃, BaSO₄, BaTiO₃, Mg(OH)₂, zeolite, boehmite, and a combination thereof, but the present invention is not limited thereto.

The organic and inorganic materials may be mixed and present in one coating layer, or a coating layer containing the organic material and a coating layer containing the inorganic material may be stacked.

In an embodiment, a pair of separators 230 may be included. The pair of separators 230 may be disposed to face both, or opposite, surfaces of the first electrode plate 210 or the second electrode plate 220, respectively. The pair of separators 230 may be wound around a winding axis along with the first electrode plate 210 and the second electrode plate 220.

In an embodiment, a first insulating plate 201 and a second insulating plate 202 may be disposed on both, or opposite, sides of the electrode assembly 200, respectively. The first insulating plate 201 and the second insulating plate 202 may contain an insulating material, such as rubber, polyethylene (PE), polypropylene (PP), or polyethylene terephthalate (PET).

The first insulating plate 201 may be formed to have a generally disc-like shape. The first insulating plate 201 may be disposed between a top surface of the electrode assembly 200 and the cap assembly 300. Therefore, the first insulating plate 201 may prevent or substantially prevent the top surface of the electrode assembly 200 from being in direct contact with the cap assembly 300, and may insulate the electrode assembly 200 from the cap assembly 300. The first insulating plate 201 may have a through hole (not shown) through which the first electrode tab E1 can pass.

The second insulating plate 202 may be formed to have a generally disc-like shape. The second insulating plate 202 may be disposed between a bottom surface of the electrode assembly 200 and the bottom part 120 of the case 100. Therefore, the second insulating plate 202 may prevent or substantially prevent the bottom surface of the electrode assembly 200 from being in direct contact with the bottom part 120 of the case 100, and insulate the electrode assembly 200 from the bottom part 120 of the case 100. The second insulating plate 202 may have a through hole (not shown) through which a second electrode tab E2 can pass.

The cap assembly 300 may be joined to the case 100 and seal the opening 130 of the case 100. As an example, the cap assembly 300 may be disposed at an upper part of the sidewall part 110, that is, the opening 130.

The sidewall part 110 may include a beading part 110b formed concavely toward the central axis C of the case 100. The beading part 110b may be disposed below the cap assembly 300, and restrict the cap assembly 300 from being inserted into the case 100 beyond a certain (e.g., predetermined) distance.

In addition, the sidewall part 110 may include a crimping part 110c that is included above the beading part 110b and bent toward the central axis C of the case 100. The crimping part 110c may be disposed above the cap assembly 300, and prevent or substantially prevent the cap assembly 300 from being separated from the case 100.

A gasket 400 may be disposed between the case 100 and the cap assembly 300. The gasket 400 may fix the cap assembly 300 to the opening 130 by an elastic restoring force thereof, electrically insulates the case 100 from the cap assembly 300, and prevents or substantially prevents inflow or outflow of moisture or an electrolyte between the case 100 and the cap assembly 300.

The gasket 400 may contain an insulating material, such as rubber, polyethylene (PE), polypropylene (PP), or polyethylene terephthalate (PET). The gasket 400 may be formed to have a generally ring-like shape and disposed inside the beading part 110b and/or the crimping part 110c. The outer surface of the gasket 400 may be in contact (e.g., close contact) with the inner surface of the beading part 110b and/or the crimping part 110c, and the inner surface of the gasket 400 may be in contact (e.g., close contact) with the outer surface of the cap assembly 300.

The cap assembly 300 may be electrically connected to the first electrode plate 210 by the first electrode tab E1. In an embodiment, the first electrode plate 210 functions as a positive electrode of the electrode assembly 200, and the cap assembly 300 may function as a positive electrode terminal of the secondary battery.

The cap assembly 300 may block the electrical coupling between the secondary battery 2 and an external device if a pressure inside the case 100 increases due to overcurrent. The cap assembly 300 may rupture when the internal pressure of the case 100 rises above a certain (e.g., predetermined) level, allowing the internal space of the case 100 to communicate with the external space. Therefore, the cap assembly 300 may reduce the risk of explosion of the secondary battery 2 if overcurrent occurs.

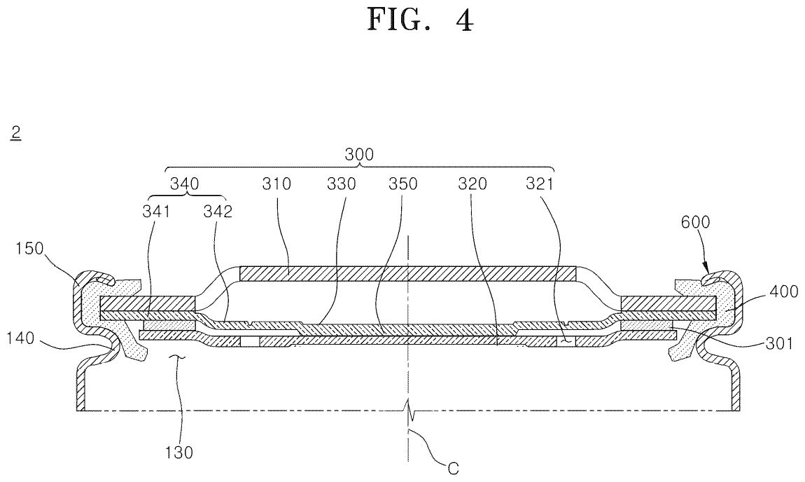

FIG. 4 is an enlarged view schematically illustrating a configuration of a cap assembly according to an embodiment of the present disclosure. Referring to FIGS. 1 to 4, the cap assembly 300 may include an upper cap 310, a lower cap 320, a vent plate 330, an extension part 340, and a contact part 350.

The upper cap 310 may form an upper exterior of the cap assembly 300, and may be disposed in the opening 130. The upper cap 310 may be electrically coupled to the first electrode plate 210 by the lower cap 320 and the vent plate 330, which are described below.

In an embodiment, the upper cap 310 may have a shape of a circular plate with a center protruding upward. The central axis of the upper cap 310 may be coaxial with the central axis C of the case 100. The central portion of the upper cap 310 may protrude outside the case 100. An edge of the upper cap 310 may be disposed inside the case 100. A circumferential surface of the edge of the upper cap 310 may be spaced by a distance (e.g., a predetermined distance) apart from the inner surface of the gasket 400. The upper cap 310 may be formed of an electrically conductive material, such as nickel, aluminum, or copper.

The upper cap 310 may be provided with an upper cap hole 311 for discharging gases generated inside the case 100 to the outside. The upper cap hole 311 may have a shape of a hole passing through the circumferential surface of the central portion of the upper cap 310. In an embodiment, a plurality of upper cap holes 311 may be provided. The plurality of upper cap holes 311 may be arranged at intervals (e.g., predetermined intervals) along the circumferential surface of the central portion of the upper cap 310.

The lower cap 320 may be disposed to face the upper cap 310 and electrically coupled to the electrode assembly 200.

The lower cap 320 may be formed to have a generally disc-like shape, and disposed inside the case 100. The lower cap 320 may be disposed under the upper cap 310. That is, the lower cap 320 may be disposed between the upper cap 310 and the electrode assembly 200. The central axis of the lower cap 320 may be coaxial with the central axis C of the case 100. The top surface of the lower cap 320 may be spaced apart from the bottom surface of the upper cap 310.

In an embodiment, an area of the lower cap 320 may be smaller than the cross-sectional area of the electrode assembly 200 perpendicular to the central axis C of the case 100. However, the area of the lower cap 320 is not limited thereto, and may be the same as or larger than the cross-sectional area of the electrode assembly 200.

The lower cap 320 may be formed of an electrically conductive material, such as nickel, aluminum, or copper. The lower cap 320 may be electrically coupled to the electrode assembly 200. As an example, an end of the first electrode tab E1 extending from the first electrode plate 210 may be connected to the bottom surface of the lower cap 320 by any of various types of joining methods, such as welding. The lower cap 320 may be electrically coupled to the upper cap 310 by the vent plate 330 described below.

A lower cap hole 321 that vertically passes through the lower cap 320 may be formed in the lower cap 320. The lower cap hole 321 may provide a path for passing gases generated inside the case 100 through the lower cap 320 if overcurrent occurs. In an embodiment, a plurality of lower cap holes 321 may be provided. The plurality of lower cap holes 321 may be arranged along a circumference centered on the central axis of the lower cap 320.

The vent plate 330 may be disposed between the upper cap 310 and the lower cap 320. The vent plate 330 may provide a current conduction path between the upper cap 310 and the lower cap 320 during normal operation of the secondary battery 2. The vent plate 330 may be deformed by the pressure of a gas generated inside the case if overcurrent occurs, and the electrical coupling between the upper cap 310 and the lower cap 320 may be blocked. The vent plate 330 may rupture if the internal pressure of the case 100 rises above a certain level (e.g., a set level), thereby opening a gas discharge path between the upper cap hole 311 and the lower cap hole 321.

The vent plate 330 may be formed to have a generally disc-like shape. The vent plate 330 may be disposed such that both top and bottom surfaces thereof face the upper cap 310 and the lower cap 320, respectively. The bottom surface of the vent plate 330 may be disposed to face the lower cap hole 321. The central axis of the vent plate 330 may be coaxial with the central axis C of the case 100. The vent plate 330 may be formed of an electrically conductive material, such as nickel, aluminum, or copper.

An insulator 301 may be disposed between the vent plate 330 and the lower cap 320. The insulator 301 may prevent or substantially prevent direct contact between the vent plate 330 and the lower cap 320, and ensure that the electrical coupling between the vent plate 330 and the lower cap 320 is achieved only by the contact part 350 described below.

The insulator 301 may be formed to have a hollow ring shape. The central axis of the insulator 301 may be coaxial with the central axis C of the case 100 and the central axis of the vent plate 330. A top surface of the insulator 301 may contact the bottom surface of the vent plate 330, and a bottom surface of the insulator 301 may contact the top surface of the lower cap 320. The insulator 301 may be formed of an insulating material, such as polyethylene (PE), polypropylene (PP), or polyethylene terephthalate (PET).

The extension part 340 may extend from the vent plate 330, and may be connected to the upper cap 310. The extension part 340 may support the vent plate 330 against the upper cap 310, and provide an electrical coupling between the upper cap 310 and the vent plate 330. In an embodiment, the extension part 340 may be formed of a same material as the vent plate 330.

The extension part 340 may include a support part 341 and a hinge part 342. The support part 341 forms a side of the exterior of the extension part 340 and is connected to the upper cap 310.

The support part 341 may be disposed to surround an end of the upper cap 310, that is, an edge region of the upper cap 310 that faces the gasket 400. As an example, the support part 341 may have a substantially U-shaped cross-section. An end of the support part 341 may contact the top surface of the upper cap 310, and another end of the support part 341 may be bent downward and contact the bottom surface of the upper cap 310. The support part 341 may be joined to the upper cap 310 by any of various types of joining methods, such as any of laser welding, ultrasonic welding, and resistance welding.

The hinge part 342 may form another side of the exterior of the extension part 340, and may be disposed between the support part 341 and the vent plate 330. The hinge part 342 may interconnect the support part 341 and the vent plate 330, and may guide deformation of the vent plate 330 if the internal pressure of the case 100 increases.

The hinge part 342 may have a generally circular ring shape, and may be disposed between the support part 341 and the vent plate 330. The inner circumferential surface of the hinge part 342 may be connected to the vent plate 330, and the outer circumferential surface of the hinge part 342 may be connected to the other end of the support part 341. The hinge part 342 may extend downward in a stepped manner from the outer circumferential surface to the inner circumferential surface. As an example, the central part of the hinge part 342 may be bent to have an L-shaped cross-section. A bending angle of the central part of the hinge part 342 may have any of various angles, other than the angle shown in FIG. 4.

If overcurrent occurs, the vent plate 330 may be deformed based on the hinge part 342. As an example, if the internal pressure in the case 100 increases due to overcurrent, gases passing through the lower cap hole 321 may press the vent plate 330 upward, and the vent plate 330 may be deformed into a shape in which the central part protrudes convexly upward due to a change in the bending angle of the hinge part 342.

The contact part 350 may protrude from the vent plate 330 toward the lower cap 320, and contact the lower cap 320. The contact part 350 may electrically couple the vent plate 330 and the lower cap 320 with each other. Therefore, current generated from the first electrode plate 210 may be transferred to the upper cap 310 sequentially through the first electrode tab E1, the lower cap 320, the contact part 350, the vent plate 330, and the extension part 340.

The contact part 350 may protrude downward from the bottom surface of the vent plate 330. A bottom surface of the contact part 350 may contact the top surface of the lower cap 320. The central axis of the contact part 350 may be coaxial with the central axis C of the case 100 and the central axis of the vent plate 330. A diameter of the contact part 350 may vary within a range smaller than the inner diameter of the insulator 301.

If the vent plate 330 deforms due to an increase in internal pressure of the case 100, the contact part 350 may be separated from the lower cap 320. Therefore, if overcurrent occurs, the electrical coupling between the lower cap 320 and the vent plate 330 may be blocked.

A thickness of a part of the vent plate 330 may increase toward the central axis C of the case 100. Here, the thickness of the vent plate 330 may refer to a vertical length of the vent plate 330 parallel to the central axis C of the case 100.

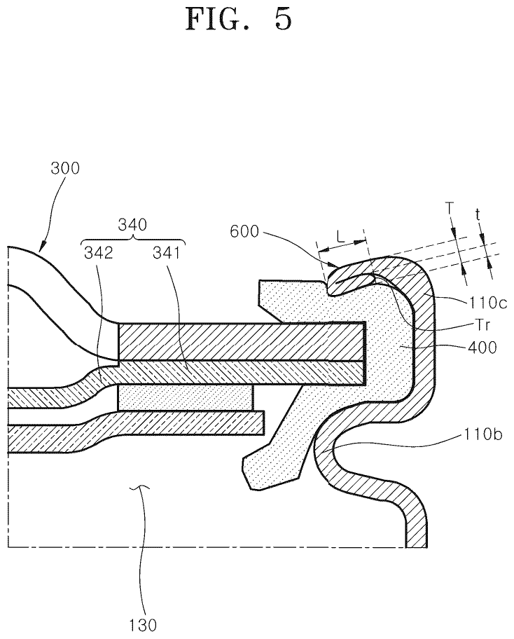

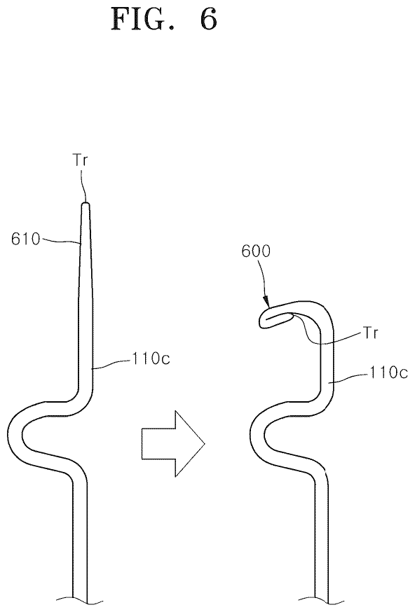

FIG. 5 is a view schematically illustrating a configuration of an exposure prevention part according to an embodiment of the present disclosure. FIG. 6 is a view schematically illustrating a process of forming the exposure prevention part according to an embodiment of the present disclosure.

Referring to FIGS. 5 and 6, an exposure prevention part 600 may be formed to prevent (prevent or substantially prevent) an end of the crimping part 110c from being exposed. The exposure prevention part 600 may prevent or substantially prevent the crimping part 110c from corroding due to contact with oxygen. In an embodiment, at the end of the crimping part 110c, a detachable Ni plating part may be made and corroded by oxygen contact if the end is exposed to the outside, which may be prevented by the exposure prevention part 600.

Herein, the end of the crimping part 110c, that is, the detachable Ni plating part is described as a trimming part Tr.

As an example, the exposure prevention part 600 may be formed by bending the end part 610 of the crimping part 110c toward the inside of the case 100. By bending the end part 610 of the crimping part 110c through a bending operation, the exposure prevention part 600 may prevent or substantially prevent direct exposure of the trimming part Tr. In an embodiment, the exposure prevention part 600 may be formed by bending the end part 610 of the crimping part 110c at least once toward the inside of the case 100.

The end part 610 of the crimping part 110c may be formed to be inclined downward toward the inside of the case to press the gasket 400. Oxygen contact at the trimming part Tr may be blocked due to enhanced sealing performance by pressing the top surface of the gasket 400 with the end part 610 in the process of forming the crimping part 110c after bending the end part 610.

In an embodiment, the end part 610 of the crimping part 110c may be formed thinner than a thickness T of the crimping part 110c. In an embodiment, to form a thickness t of the end part 610 of the crimping part 110c equal to the thickness T of the original material of the crimping part 110c, the thickness t of the end part 610 is designed to be 50% or less of the thickness T of the crimping part 110c.

According to an embodiment, the end part 610 of the crimping part 110c may be formed to have a thickness that linearly decreases from the crimping part 110c. For example, the crimping part 110c may be formed to have a thickness T of 2.5 mm, and the end part 610 may be formed to have a thickness t of 1.25 mm. In an embodiment, the length L of the end part 610 may be 3 to 5 mm, and the end part 610 may be bent once. In an embodiment, the end part 610 may have a length L of 4 mm and bent once such that the end part 610 is folded to become 2 mm.

As shown in FIG. 5, as the end part 610 may be bent once such that the trimming part Tr faces the outside of the case 100, the trimming part Tr may be disposed at the outer side based on a contact area between the end part 610 and the gasket 400, thereby blocking the contact with oxygen.

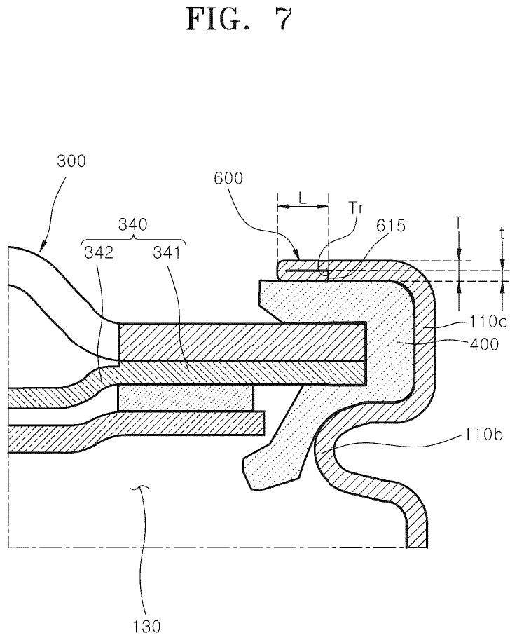

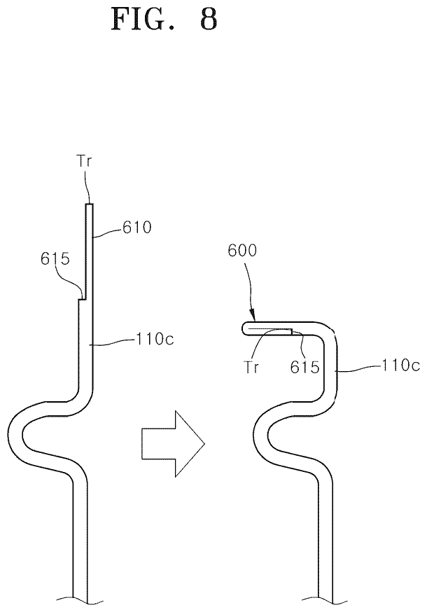

FIG. 7 is another example schematically illustrating a configuration of the exposure prevention part according to an embodiment of the present disclosure; and FIG. 8 is a view schematically illustrating a process of forming the exposure prevention part of FIG. 7.

Referring to FIGS. 7 and 8, the exposure prevention part 600 may be formed by bending the end part 610 of the crimping part 110c toward the inside of the case 100. The exposure prevention part 600 may prevent or substantially prevent direct exposure of the trimming part Tr by bending the end part 610 of the crimping part 110c through a bending operation. In an embodiment, the exposure prevention part 600 may be formed by bending the end part 610 of the crimping part 110c at least once toward the inside of the case 100 to overlap.

The end part 610 of the crimping part 110c may be formed thinner than the thickness T of the crimping part 110c. In an embodiment, to form the thickness t of the end part 610 of the crimping part 110c equal to the thickness T of the original material of the crimping part 110c, the thickness t of the end part 610 is designed to be 50% or less of the thickness T of the crimping part 110c.

According to an embodiment, a step 615 may be formed between the crimping part 110c and the end part 610. The step 615 may be formed by the difference between the thickness T of the crimping part 110c and the thickness t of the end part 610, and since, in an embodiment, the thickness t of the end part 610 is formed to be 50% or less than the thickness T of the crimping part 110c, the trimming part Tr of the end part 610 comes into contact with the step 615 when bent once toward the inside of the case 100. Therefore, a two-layer end part 610 may be formed to have a same thickness as that of the crimping part 110c.

As shown in FIG. 7, the end part 610 may be bent once to bring the trimming part Tr into contact with the step 615, and the trimming part Tr may be disposed at the outer side based on the contact area between the end part 610 and the gasket 400, thereby blocking contact with oxygen.

A secondary battery 2 according to another embodiment of the present disclosure will be described below.

The secondary battery 2 according to the present embodiment may have the same configuration except for the detailed configuration of the gasket 400 contacting the exposure prevention part 600 of the secondary battery according to the previously described embodiment of the present disclosure. Accordingly, in describing the secondary battery 2 according to the present embodiment, only a configuration of the gasket 400, which is different from the secondary battery 2 according to the embodiment described above, will be described. For the remaining configuration of the secondary battery 2 according to the present embodiment, the description of the secondary battery 2 according to the embodiment described above may be applied as is.

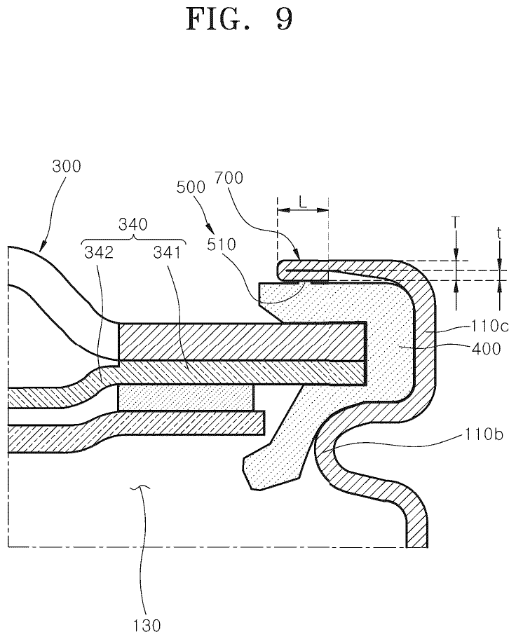

FIG. 9 is a view schematically illustrating a configuration of an exposure prevention part according to an embodiment of the present disclosure. Referring to FIG. 9, an exposure prevention part 700 may be formed by bending the end part 610 of the crimping part 110c toward the inside of the case 100. The exposure prevention part 700 may prevent or substantially prevent direct exposure of a trimming part Tr by bending the end part 610 of the crimping part 110c through a bending operation. In an embodiment, the end part 610 of the crimping part 110c may be formed by bending the end part 610 at least once toward the inside of the case 100 to overlap.

In addition, exposure of the trimming part Tr of the crimping part 110c may be prevented or substantially prevented by a sealing part 500 formed on the gasket 400. The sealing part 500 may be formed on the gasket 400 to seal a space between the gasket 400 and the end part 610. In an example, the sealing part 500 may protrude from the gasket 400 to form a close contact protrusion 510 that is in contact (e.g., close contact) with the bottom surface of the end part 610.

Here, the exposure prevention part 700 formed on the end part 610 of the crimping part 110c may be formed parallel to the top surface of the gasket 400, and the sealing part 500 formed as the close contact protrusion 510 may be brought into contact with the bottom surface of the exposure prevention part 700, thereby blocking the inflow of external air to prevent or substantially prevent the trimming part Tr from contacting oxygen and thus preventing or substantially preventing rust formation.

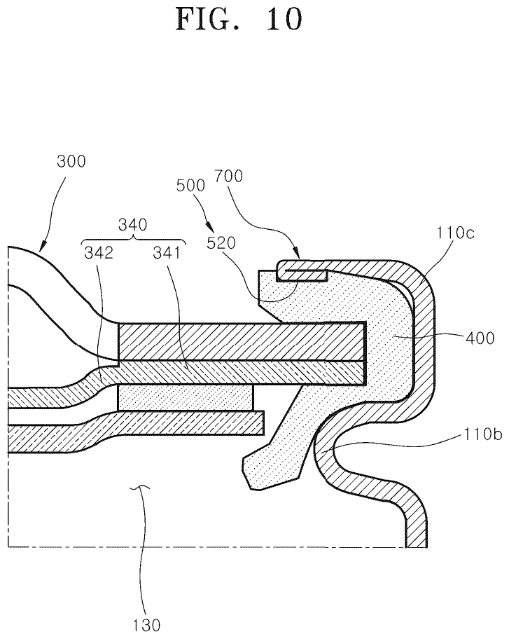

FIGS. 10 to 12 are views schematically illustrating some other examples of sealing parts according to embodiments of the present disclosure.

Referring to FIG. 10, in an embodiment, a sealing part 500 may be formed as an accommodation groove 520. The accommodation groove 520 may form a space for accommodating an exposure prevention part 700 formed at an end part 610 of a crimping part 110c, and improve airtightness by increasing a contact area.

The sealing part 500 formed as the accommodation groove 520 may be formed in a size corresponding to the exposure prevention part 700. In an embodiment, the end part 610 may be formed with a length of 4 mm, and may be folded once to form the exposure prevention part 700. In an embodiment, the exposure prevention part 700 may be formed with a 2 mm overlap, and the accommodation groove 520 may be formed to have a 2 mm recess to accommodate the exposure prevention part 700.

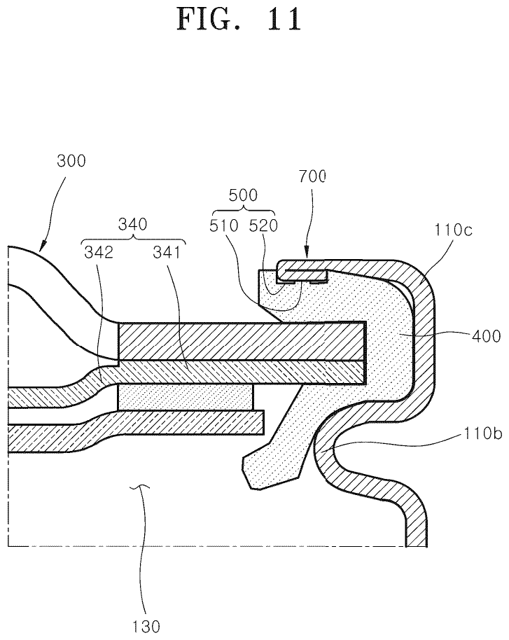

Referring to FIG. 11, a sealing part 500 may include an accommodation groove 520 and a close contact protrusion 510. In an embodiment, an end part 610 may be formed with a length of 4 mm, and folded once to form an exposure prevention part 700. In an embodiment, the exposure prevention part 700 may be formed with a 2 mm overlap, and the accommodation groove 520 may be formed to have a 2 mm recess to accommodate the exposure prevention part 700.

In addition, the close contact protrusion 510 protruding upward may be formed in the accommodation groove 520 to contact the bottom surface of the exposure prevention part 700, thereby improving airtightness.

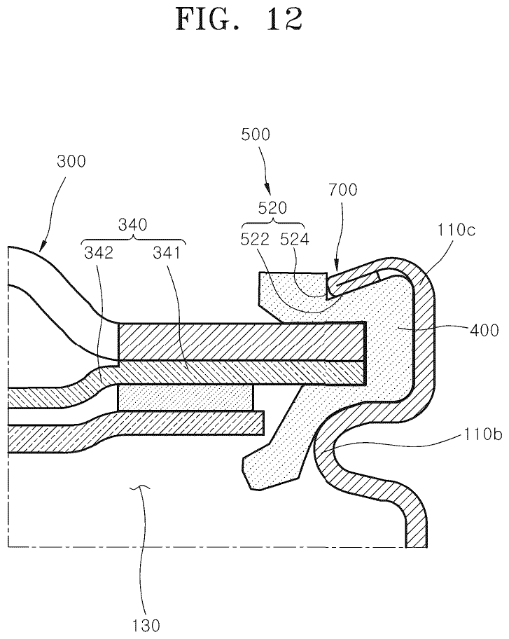

Referring to FIG. 12, the sealing part 500 may be formed as an accommodation groove 520, and the accommodation groove 520 may include an accommodation inclined surface 522 contacting the bottom surface of an exposure prevention part 600, and an accommodation vertical surface 524 extending vertically from an end of the accommodation inclined surface 522. Accordingly, a bottom surface of the exposure prevention part 700 may contact the accommodation inclined surface 522, and a side of the exposure prevention part 700 may contact the accommodation vertical surface 524, thereby forming a wide contact area, and, thus, airtightness can be improved.

A secondary battery 2 according to another embodiment of the present disclosure will be described below.

The secondary battery 2 according to the present embodiment may have a same configuration except for a configuration of the gasket 400 contacting the exposure prevention part 600 of the secondary battery according to the previously described embodiment of the present disclosure. Accordingly, in describing the secondary battery 2 according to the present embodiment, only a configuration of an exposure prevention part 800, which is different from the secondary battery 2 according to the embodiment described above, will be described. For the remaining configuration of the secondary battery 2 according to the present embodiment, the description of the secondary battery 2 according to the embodiment described above may be applied as is.

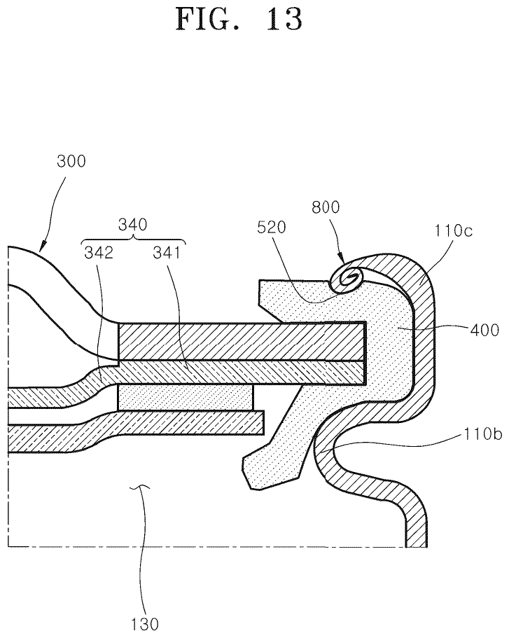

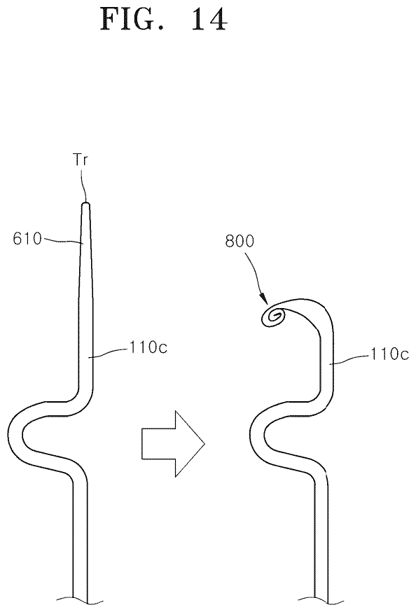

FIG. 13 is a view schematically illustrating a configuration of an exposure prevention part according to another embodiment of the present disclosure; and FIG. 14 is a view schematically illustrating a process of forming the exposure prevention part of FIG. 13. Referring to FIGS. 13 and 14, an exposure prevention part 800 may be formed by winding an end part 610 of the crimping part 110c into a roll shape.

As shown in FIG. 14, the end part 610 of the crimping part 110c may be formed thinner than the thickness T of the crimping part 110c. In an embodiment, to form the thickness t of the end part 610 of the crimping part 110c equal to the thickness T of the original material of the crimping part 110c, the thickness t of the end part 610 is designed to be 50% or less of the thickness T of the crimping part 110c.

According to an embodiment, the end part 610 of the crimping part 110c may be formed to have a thickness that linearly decreases from the crimping part 110c. In an embodiment, for example, the crimping part 110c may be formed to have a thickness T of 2.5 mm, and the end part 610 may be formed to have a thickness t of 1.25 mm. In an embodiment, the length L of the end part 610 may be 3 to 5 mm, and the end part 610 may be wound into a roll shape, thereby forming an exposure prevention part 800.

The roll-shaped exposure prevention part 800 may press the top surface of a gasket 400 by crimping the crimping part 110c, maintain airtightness by a contacting force, and prevent or substantially prevent a trimming part Tr from being exposed to the outside.

Here, an accommodation groove 520 accommodating a part of the exposure prevention part 800 may be formed in the gasket 400. In an embodiment, the accommodation groove 520 may be formed in a semicircular shape.

The shape of the accommodation groove 520 corresponds to the exposure prevention part 800 formed in a roll shape to form a larger contact area, thereby improving airtightness.

A secondary battery 2 according to another embodiment of the present disclosure will be described below.

The secondary battery 2 according to the present embodiment may have a same configuration except for a configuration of the exposure prevention part 600 of the secondary battery according to the previously described embodiment of the present disclosure. Accordingly, in describing the secondary battery 2 according to the present embodiment, only a configuration of an exposure prevention part 900, which is different from the secondary battery 2 according to the embodiment described above, will be described. For the remaining configuration of the secondary battery 2 according to the present embodiment, the description of the secondary battery 2 according to the embodiment described above may be applied as is.

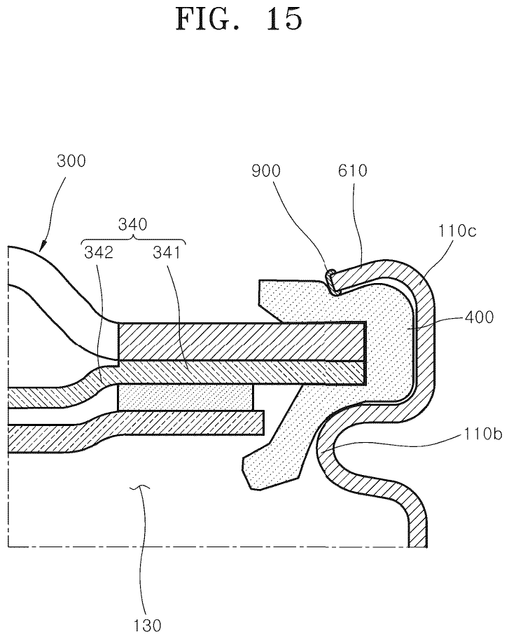

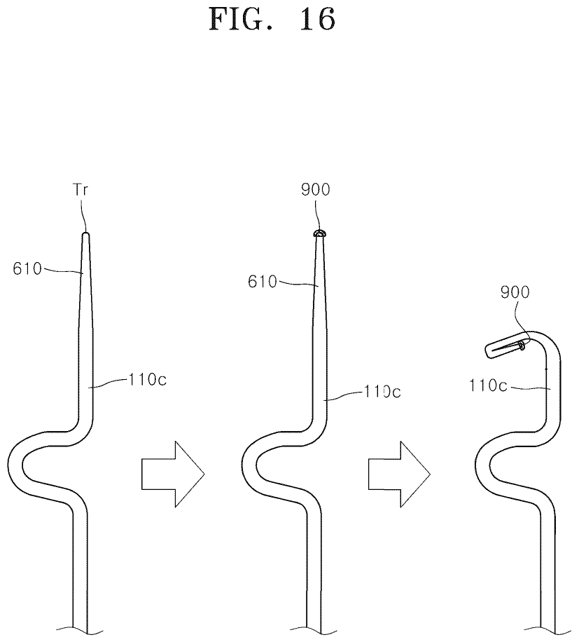

FIG. 15 is a view schematically illustrating a configuration of an exposure prevention part according to another embodiment of the present disclosure, and FIG. 16 is a view schematically illustrating a process of forming the exposure prevention part of FIG. 15. Referring to FIGS. 15 and 16, an exposure prevention part 900 may be formed by coating a trimming Tr of the crimping part 110c with a resin.

The exposure prevention part 900 may prevent or substantially prevent the crimping part 110c from corroding due to contact with oxygen, and may be formed by coating the trimming part Tr, which is a detachable Ni plating part, with a resin. In an embodiment, the resin may be epoxy, polyurethane, or polyimide. That is, by applying a resin coating on the trimming part Tr for preventing corrosion, oxygen exposure of the trimming part Tr may be prevented or substantially prevented and, thus, rust formation may be prevented or substantially prevented.

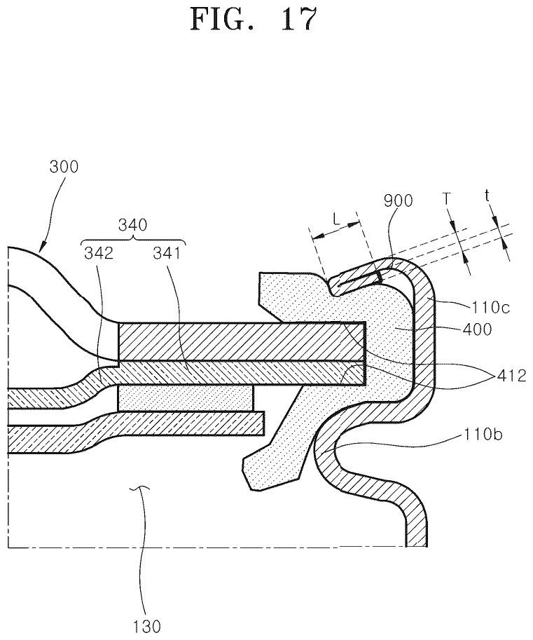

FIG. 17 is a view schematically illustrating another example of the exposure prevention part according to an embodiment of the present disclosure. Referring to FIG. 17, the exposure prevention part 900 may securely prevent or substantially prevent oxygen exposure by coating the trimming part Tr of the crimping part 110c with a resin, and bending the end part 610 of the crimping part 110c as described in the previously described embodiments.

In an embodiment, the end part 610 of the crimping part 110 may be formed thinner than the thickness T of the crimping part 110c, and the end part 610 is folded at least once toward the inside of the case 100 to overlap, thereby improving airtightness due to the structural characteristic of the trimming part Tr being folded along with the resin coating.

As shown in FIG. 17, the end part 610 of the crimping part may be folded once to overlap, or wound to form a roll shape as shown in the previously described embodiment.

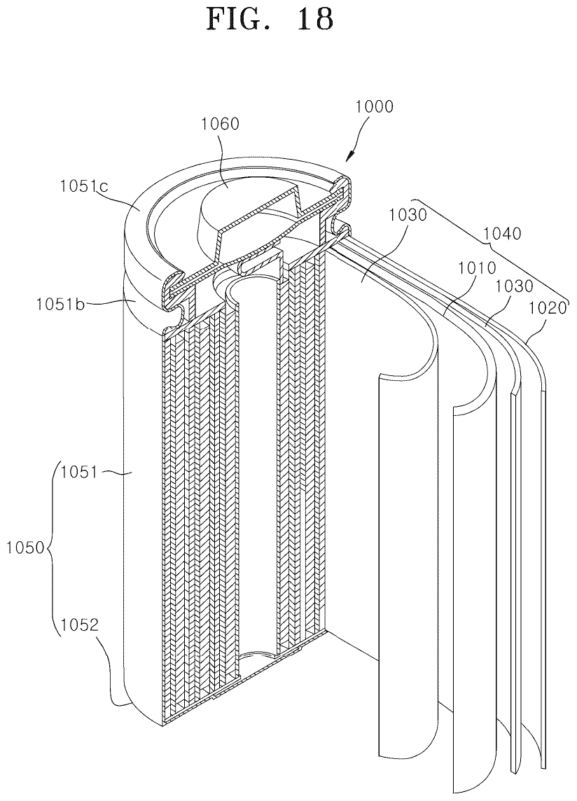

FIG. 18 is a cross-sectional view schematically illustrating a secondary battery according to another embodiment of the present disclosure. A secondary battery 1000 shown in FIG. 18 may be an example of the secondary battery 2 described with reference to FIGS. 2 and 3. Accordingly, the secondary battery 1000 will be briefly described below, and the contents not described herein may be equally applied to those described with reference to FIGS. 2 and 3.

Referring to FIG. 18, the secondary battery 1000 includes an electrode assembly 1040, a case 1050 accommodating the electrode assembly 1040, and a cap assembly 1060 that seals the case 1050 by being joined to an opening of the case 1050. The electrode assembly 1040 may include a first electrode 1010, a second electrode 1020, and a separator 1030 located between the first electrode 1010 and the second electrode 1020 and preventing or substantially preventing a short circuit between the first electrode 1010 and the second electrode 1020 while allowing the movement of lithium ions. In addition, the case 1050 may include a sidewall part 1051, a bottom part 1052 closing an end of the sidewall part 1051, and an opening formed in another end part of the sidewall part 1051. The sidewall part 1051 may include a beading part 1051b formed concavely toward the inside of the case 1050, and a crimping part 1051c formed by bending toward the inside of the case 1050.

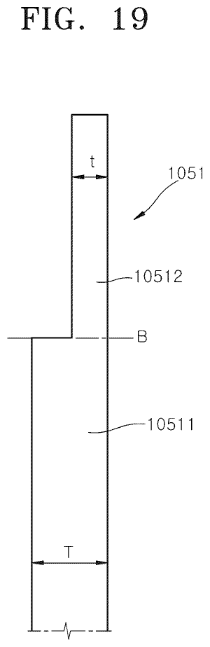

FIG. 19 is a view illustrating an example of a sidewall part of a case of the secondary battery of FIG. 18. Referring to FIG. 19, the sidewall part 1051 includes a first region 10511 and a second region 10512.

The first region 10511 constitutes a part of the sidewall part 1051. The first region 10511 may form a general exterior of the sidewall part 1051. The first region 10511 may be formed from an end of the sidewall part 1051. The first region 10511 may be formed in a region to a beading part 1051b. In an embodiment, for example, the first region 10511 may include the beading part 1051b. In an embodiment, the first region 10511 may be formed in a region from the beading part 1051b to a crimping part 1051c. The first region 10511 is formed to have a first thickness T.

The second region 10512 constitutes another part of the sidewall part 1051. The second region 10512 is located adjacent to an end of the sidewall part 1051. The second region 10512 is formed by extending from the first region 10511. The second region 10512 may be formed in a region from the first region 10511 to another end of the sidewall part 1051. The second region 10512 is formed to have a second thickness t. The second thickness t is thinner than the first thickness T. The second thickness t is less than the first thickness T.

In an embodiment, the second region 10512 may be formed by pressing the first region 10511. For example, the second region 10512 may be formed by pressing the first region 10511 through a forging process.

The sidewall part 1051 may be divided into the first region 10511 and the second region 10512. However, this is an example, and the sidewall part 1051 may further include an additional region, in addition to the first region 10511 and the second region 10512. For example, the sidewall part 1051 may further include a third region (not shown). The third region may be formed from an end of the sidewall part 1051. The third region may be formed in a region from an end of the sidewall part 1051 to the first region 10511. The third region may be formed in a region from an end of the sidewall part 1051 to before the beading part 1051b. The third region may not include the beading part 1051b. The third region may form a general exterior of the sidewall part 1051. The third region may be formed thinner than the first thickness T. Therefore, the weight of the secondary battery 1000 may be reduced. In addition, the case 1050 may contribute to increasing a capacity of the electrode assembly 1040.

Herein, the case in which the sidewall part 1051 includes the first region 10511 and the second region 10512 will be described. In FIG. 19, “B” represents a boundary between the first region 10511 and the second region 10512.

In an embodiment, the first region 10511 may be formed with a uniform (uniform or substantially uniform) first thickness T as a whole. The first region 10511 may be formed with the first thickness T including a margin of error that occurs during the process. Accordingly, the first thickness T may refer to an average thickness with a margin of error of ±5%.

The second region 10512 may be formed with the second thickness t by extending from the first region 10511. As described above, the second thickness t is smaller than the first thickness T. Here, the second thickness t refers to the average thickness of the second region 10512.

In this way, the sidewall part 1051 may be formed with a second thickness t that is relatively smaller than the second region 10512. This may facilitate machining of the other end of the sidewall part 1051. For example, the other end of the sidewall part 1051 may be more easily bent. In an embodiment, the other end of the sidewall part 1051 may be formed to be relatively sharper. Accordingly, the sidewall part 1051 may be inserted into a gasket 1070 rather than having one end of the crimping part 1051c located outside the gasket 1070. The other end of the sidewall part 1051 may be embedded in the gasket 1070 and not exposed to the outside. The other end of the sidewall part 1051 may be protected by the gasket 1070 to prevent or substantially prevent damage thereto. For example, rust formation in the sidewall part 1051 may be prevented or substantially prevented by the gasket 1070.

In an embodiment, for example, the second thickness t may be 35% to 65% of the first thickness T. In an embodiment, for example, the second thickness t may be 40% to 60% of the first thickness T. In an embodiment, for example, the second thickness t may be 45% to 55% of the first thickness T. In an embodiment, for example, the second thickness t may be approximately 50% of the first thickness T.

If the second thickness t is less than 25% of the first thickness T, the second region 10512 may be formed excessively thin and has reduced strength. In addition, if the second thickness t is greater than 65% of the first thickness T, the second region 10512 may not be inserted into the gasket 70. Accordingly, in an embodiment, the second thickness t is 25% to 65% of the first thickness T.

In an embodiment, for example, the second thickness t may be in a range from 0.0625 mm to 0.1625 mm. In an embodiment, for example, the second thickness t may be in a range from 0.09 mm to 0.16 mm. In an embodiment, for example, the second thickness t may be in a range from 0.10 mm to 0.15 mm. In an embodiment, for example, the second thickness t may be in a range from 0.11 mm to 0.14 mm. In an embodiment, for example, the second thickness t may be in a range from 0.12 mm to 0.13 mm. In an embodiment, for example, the second thickness t may be approximately 0.125 mm.

If the second thickness t is less than 0.0625 mm, the second region 10512 may be formed too thin and have reduced strength. In addition, if the second thickness t exceeds 0.1625 mm, the thickness of the first region 10511 may be excessively large, and a capacity of the secondary battery 1000 may be reduced. Accordingly, in an embodiment, the second thickness t is in a range from 0.0625 mm to 0.1625 mm.

For example, as shown in FIG. 19, the first region 10511 may be formed with a uniform first thickness T as a whole. The first region 10511 may be formed in a plate shape with the first thickness T and bent to form a curved surface. Therefore, the first region 10511 may be formed in a cylindrical shape with the first thickness T.

For example, as shown in FIG. 19, the second region 10512 may be formed with a uniform second thickness t as a whole. Accordingly, the second region 10512 may be formed in a plate shape with the second thickness t, and bent to have a curved surface. Therefore, the second region 10512 may be formed in a cylindrical shape with the second thickness t.

A step may be formed at the boundary B between the first region 10511 and the second region 10512. The step may be formed by the difference between the first thickness T and the second thickness t. Since the second region 10512 is formed with a uniform thickness, it may be formed by a simple process.

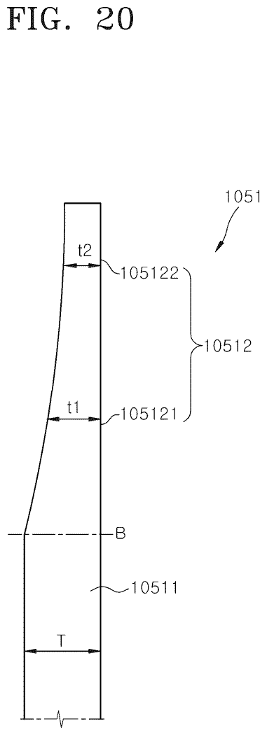

FIG. 20 is a view illustrating another example of a sidewall part of a case of the secondary battery of FIG. 18. Referring to FIG. 20, the sidewall part 1051 includes a first region 10511 and a second region 10512.

The first region 10511 is formed to have the first thickness T. Description of the first thickness T is the same or similar to that described in FIG. 19. The first region 10511 includes a beading part 1051b formed concavely toward the inside of the case 1050.

The second region 10512 is formed to have a second thickness t that is smaller than the first thickness T. Description of the second thickness t is the same or similar to that described is FIG. 19. For example, the second thickness t may be 25% to 65% of the first thickness T. For example, the second thickness t may be in a range from 0.0625 mm to 0.1625 mm.

The second region 10512 is located adjacent to an end of the sidewall part 1051. In an embodiment, the second region 10512 may be formed by pressing the first region 10511. For example, the second region 10512 may be formed by pressing the first region 10511 through a forging process.

FIG. 20 shows a boundary B between the first region 10511 and the second region 10512. For example, as shown in FIG. 20, the first region 10511 may be formed to have a uniform first thickness T as a whole. Accordingly, the first region 10511 may be formed in a plate shape with the first thickness T and bent to form a curved surface. Therefore, the first region 10511 may be formed in a cylindrical shape with the first thickness T.

In an embodiment, as shown in FIG. 20, the second region 10512 may be formed with a non-uniform thickness. In an embodiment, the second region 10512 may be formed with an average thickness of the second thickness t as a whole. For example, the second region 10512 may be thinner from the boundary B to an end of the sidewall part 1051.

A part of the second region 10512 may be formed with a third thickness t1. The third thickness t1 is smaller than the first thickness T. For convenience, the partial region formed with the third thickness t1 may be referred to as a first portion 105121. The first portion 105121 may be located relatively close to the first region 10511.

Another part of the second region 10512 may be formed with a fourth thickness t2. The fourth thickness t2 is smaller than the first thickness T. The fourth thickness t2 is smaller than the third thickness t1. For convenience, the partial region with the fourth thickness t2 may be referred to as a second portion 105122. The second portion 105122 may be located relatively far from the first region 10511 and relatively close to the end of the sidewall part 1051.

In an embodiment, the second thickness t may be an average of the thicknesses forming the second region 10512. For example, the second thickness t may be an average of the third thickness t1 and the fourth thickness t2.

For example, as shown in FIG. 20, the second region 10512 may be thinner while forming a continuous surface from the boundary B to the end of the sidewall part 1051. In this case, the first portion 105121 and the second portion 105122 may be connected by a curved or flat surface in the direction toward the inside of the case 1050. Here, the first portion 105121 and the second portion 105122 may be spaced apart from each other, and one or more parts formed with a thickness smaller than the third thickness t1 and larger than the fourth thickness t2 may be further located between the first portion 105121 and the second portion 105122.

Due to such a structure, the second region 10512 may have a sharply-formed end of the sidewall part 1051, while exhibiting high strength overall. Therefore, the crimping part 1051c may be more easily inserted into a gasket 1070. In addition, the sidewall part 1051 may better protect an electrode assembly 1040 and/or an electrolyte from external impacts.

In an embodiment, for example, unlike FIG. 20, a step may be formed at the boundary B between the first region 10511 and the second region 10512. That is, the second region 10512 may extend from the first region while forming a step therewith. Here, the step may be formed by the difference between the first thickness T and the second thickness t. For example, the step may be formed by the difference between the first thickness T and the third thickness t1.

In an embodiment, for example, as shown in FIG. 20, the second region 10512 may extend from the first region 10511 by forming a surface connecting with the first region 10511 without a step at the boundary B. In an embodiment, for example, the second region 10512 may extend while forming a curved surface with the first region 10511 at the boundary B. In an embodiment, for example, the second region 10512 may extend while forming an angle with the first region 10511 at the boundary B.

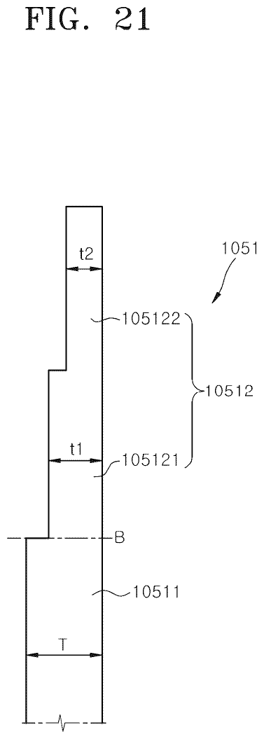

FIG. 21 is a view illustrating another example of a sidewall part of a case according to an embodiment of the present disclosure. Referring to FIG. 21, the sidewall part 1051 includes a first region 10511 and a second region 10512.

The first region 10511 is formed with the first thickness T. Description of the first thickness T is the same or similar to that described in FIGS. 19 and 20. The first region 10511 includes a beading part 1051b formed concavely toward the inside of a case 1050.

The second region 10512 is formed with a second thickness t that is smaller than the first thickness T. Description of the second thickness t is the same or similar to that described in FIGS. 19 and 20. In an embodiment, for example, the second thickness t may be 25% to 65% of the first thickness T. In an embodiment, for example, the second thickness t may range from 0.0625 mm to 0.1625 mm.

The second region 10512 is located adjacent to the end of the sidewall part 1051. In an embodiment, the second region 10512 may be formed by pressing the first region 10511. For example, the second region 10512 may be formed by pressing the first region 10511 through a forging process. In FIG. 21, B represents the boundary between the first region 10511 and the second region 10512.

The first region 10511 may be formed with a uniform first thickness T as a whole. Accordingly, the first region 10511 may be formed in a plate shape with the first thickness T and bent to form a curved surface. Therefore, the first region 10511 may be formed in a cylindrical shape with the first thickness T.

The second region 10512 may be formed with a non-uniform thickness. The second region 10512 may be formed to have the second thickness t, which is an overall average thickness. For example, the second region 10512 may be thinner from the boundary B toward the end of the sidewall part 1051.

A part of the second region 10512 may be formed with a third thickness t1. The third thickness t1 is smaller than the first thickness T. For convenience, the partial region formed with the third thickness t1 may be referred to as a first portion 105121. The first portion 105121 may be located relatively adjacent to the first region 10511.

Another part of the second region 10512 may be formed with a fourth thickness t2. The fourth thickness t2 is smaller than the first thickness T. The fourth thickness t2 is smaller than the third thickness t1. For convenience, the partial region with the fourth thickness t2 may be referred to as a second portion 105122. The second portion 105122 is located relatively far from the first region 10511 and relatively close to the end of the sidewall part 1051.

In an embodiment, the second thickness t may be an average of the thicknesses forming the second region 10512. For example, the second thickness t may be an average of the third thickness t1 and the fourth thickness t2.

For example, the second region 10512 may be thinner while forming a discontinuous surface from the boundary B to the end of the sidewall part 1051. For example, the second portion 105122 may extend from the first portion 105121 while forming a step. For example, a step may be formed between the first portion 105121 and the second portion 105122 by the difference between the third thickness t1 and the fourth thickness t2.

In addition, for example, the second region 10512 may further include a third portion (not shown) formed with a fifth thickness smaller than the third thickness t1 and larger than the fourth thickness t2. For example, the third portion may be located between the first portion 105121 and the second portion 105122. For example, the third portion may form a step with at least one of the first portion 105121 and the second portion 105122. For example, the third portion may form a first step with the first portion 105121, and a second step with the second portion 105122. Here, the first step may be the difference between the third thickness t1 and a fifth thickness. In addition, the second step may be the difference between the fourth thickness t2 and the fifth thickness.

Due to such a structure, the second region 10512 may have a sharply-formed end of the sidewall part 1051, while exhibiting high strength overall. Therefore, the crimping part 1051c may be more easily inserted into the gasket 1070. In addition, the sidewall part 1051 may better protect an electrode assembly 1040 and/or an electrolyte from external impacts.

For example, as shown in FIG. 21, a step may be formed at the boundary B between the first region 10511 and the second region 10512. That is, the second region 10512 may extend from the first region 10511 while forming a step with the first region 10511. Here, the step may be formed by the difference between the first thickness T and the second thickness t. For example, the difference may be formed by the difference between the first thickness T and the third thickness t1.

In an embodiment, for example, unlike FIG. 21, the second region 10512 may extend from the first region 10511 by forming a surface connected to the first region 10511 without a step at the boundary B. For example, the second region 10512 may extend while forming a curved surface with the first region 10511 at the boundary B. In an embodiment, for example, the second region 10512 may extend while forming an angle with the first region 10511 at the boundary B.

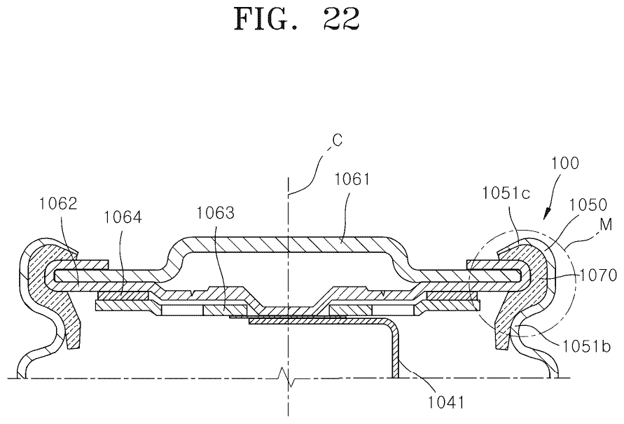

FIG. 22 is a cross-sectional view illustrating an example of the upper portion of a case according to an embodiment of the present disclosure.

As described above, a cap assembly 1060 may be joined to the opening of a case 1050 to close the case 1050. The cap assembly 1060 may include a vent plate 1062. Additionally, the cap assembly 1060 may further include a lower cap 1063 and an insulator 1064. Additionally, the cap assembly 1060 may further include an upper cap 1061.

The upper cap 1061 may form an upper exterior of the cap assembly 1060, and may be disposed in the opening. The upper cap 1061 may be electrically coupled to a first electrode 1010 by the lower cap 1063 and the vent plate 1062.

For example, the upper cap 1061 may have a disc-like shape with a central portion protruding convexly upward. The central axis of the upper cap 1061 may be coaxial with the central axis C of the case 1050. The central portion of the upper cap 1061 may protrude toward the outside of the case 1050. An edge of the upper cap 1061 may be disposed inside the case 1050. A circumferential surface of the edge of the upper cap 1061 may be spaced by a distance (e.g., a predetermined distance) apart from the inner surface of the gasket 1070. The upper cap 1061 may be formed of an electrically conductive material, such as nickel, aluminum, copper, iron, or an iron alloy.

The lower cap 1063 may be disposed to face the upper cap 1061 and electrically coupled to the electrode assembly 1040. The lower cap 1063 may be formed to have a generally disc-like shape and disposed inside the case 1050. The lower cap 1063 may be disposed under the upper cap 1061. That is, the lower cap 1063 may be disposed between the upper cap 1061 and the electrode assembly 1040. The central axis of the lower cap 1063 may be coaxial with the central axis C of the case 1050. A top surface of the lower cap 1063 may be disposed apart from a bottom surface of the upper cap 1061.

The lower cap 1063 may be formed of an electrically conductive material, such as nickel, aluminum, or copper. The lower cap 1063 may be electrically coupled to the electrode assembly 1040. The lower cap 1063 may be electrically coupled to the upper cap 1061 by the vent plate 1062.

The vent plate 1062 may be disposed between the upper cap 1061 and the lower cap 1063. The vent plate 1062 may provide a current conduction path between the upper cap 1061 and the lower cap 1063 during normal operation of a secondary battery 1000. A shape of the vent plate 1062 may be deformed by pressure of a gas generated in the case if overcurrent occurs, and the electrical coupling between the upper cap 1061 and the lower cap 1063 may be blocked. The vent plate 1062 may rupture if the internal pressure in the case 1050 exceeds a certain (e.g., predetermined) level, and a gas discharge path may open.

The vent plate 1062 may be formed to have a generally disc-like shape. The top and bottom surfaces of the vent plate 1062 may be disposed to face the upper cap 1061 and the lower cap 1063, respectively. The central axis of the vent plate 1062 may be coaxial with the central axis C of the case 1050. The vent plate 1062 may be formed of an electrically conductive material, such as nickel, aluminum, or copper.

In an embodiment, the cap assembly 1060 may be formed without the upper cap 1061. In this case, the bottom surface of the vent plate 1062 may be disposed to face the lower cap 1063. In addition, the vent plate 1062 may function as a terminal, instead of the upper cap 1061. For example, the vent plate 1062 may be connected to the first electrode 1010 and function as a first electrode terminal of the secondary battery 1000.

The insulator 1064 may be disposed between the vent plate 1062 and the lower cap 1063. The insulator 1064 may be formed to have a hollow ring shape. The central axis of the insulator 1064 may be coaxial with the central axis C of the case 1050 and the central axis of the vent plate 1062. A top surface of the insulator 1064 may contact the bottom surface of the vent plate 1062, and a bottom surface of the insulator 1064 may contact the top surface of the lower cap 1063. The insulator 1064 may be formed of an insulating material, such as polyethylene (PE), polypropylene (PP), or polyethylene terephthalate (PET).

In an embodiment, if overcurrent occurs, the vent plate 1062 may be deformed based on a notch. For example, if the internal pressure of the case 1050 increases due to overcurrent, gas passing through the lower cap 1063 may press the vent plate 1062 upward, and the vent plate 1062 may be deformed into a shape in which the central portion protrudes convexly upward due to a change in the bending angle of the notch.

The gasket 1070 may be disposed between the case 1050 and the cap assembly 1060. The gasket 1070 may allow the cap assembly 1060 to be fixed to the opening by an elastic restoring force thereof. The gasket 1070 may electrically insulate the case 1050 and the cap assembly 1060 from each other. The gasket 1070 may prevent or substantially prevent inflow and outflow of moisture or an electrolyte between the case 1050 and the cap assembly 1060.

The gasket 1070 may include an insulating material. For example, the gasket 1070 may include an insulating material, such as rubber, polyethylene (PE), polypropylene (PP), or polyethylene terephthalate (PET).

The gasket 1070 may be formed in a generally ring shape. The gasket 1070 may be disposed inside a beading part 1051b and/or a crimping part 1051c. For example, the outer surface of the gasket 1070 may be in contact (e.g., close contact) with the inner surface of the beading part 1051b and/or the crimping part 1051c, and the inner surface of the gasket 1070 may be in contact (e.g., close contact) with the outer surface of the cap assembly 1060.

As shown in FIG. 22, the end of the sidewall part 1051 may be bent toward the inside of the case 1050 to come into contact with the gasket 1070. For example, the end of the sidewall part 1051 may press against one point of the gasket 1070 and compress the point of the gasket 1070.

In an embodiment, for example, a compression rate of one point of the gasket 1070 may be 30% or more. In an embodiment, for example, the compression rate of one point of the gasket 1070 may be 31% or more. In an embodiment, for example, the compression rate of one point of the gasket 1070 may be 32% or more. In an embodiment, for example, the compression rate of one point of the gasket 1070 may be 33% or more. In an embodiment, for example, the compression rate of one point of the gasket 1070 may be 34% or more. In an embodiment, for example, the compression rate of one point of the gasket 1070 may be 35% or more. In an embodiment, for example, the compression rate of one point of the gasket 1070 may be 36% or more. In an embodiment, for example, the compression rate of one point of the gasket 1070 may be 37% or more. In an embodiment, for example, the compression rate of one point of the gasket 1070 may be 38% or more. In an embodiment, for example, the compression rate of one point of the gasket 1070 may be 39% or more. In an embodiment, for example, the compression rate of one point of the gasket 1070 may be 40% or more.

In an embodiment, for example, the compression rate of one point of the gasket 1070 may be 90% or less. In an embodiment, for example, the compression rate of one point of the gasket 1070 may be 80% or less. In an embodiment, for example, the compression rate of one point of the gasket 1070 may be 70% or less. In an embodiment, for example, the compression rate of one point of the gasket 1070 may be 60% or less. In an embodiment, for example, the compression rate of one point of the gasket 1070 may be 50% or less.

Here, the point may be a point where the end of the sidewall part 1051 and the gasket 1070 are in contact with each other. For example, the point may be a point expressed as one or more points on the gasket 1070. For example, the point may be a section expressed in the form of a line connecting multiple points formed on the gasket 1070. For example, the section expressed in the form of a line may be a region expressed in the form of a surface by the thickness of the end of the sidewall part 1051. For example, based on the form of the end of the sidewall part 1051, this point may be expressed in the form of the mixture of one or more dots and/or one or more lines.

Here, the compression rate may represent a ratio of a thickness after compression to a thickness before compression. The thickness before compression may represent the thickness of the gasket 1070 in a state before the gasket 1070 comes into contact with the end of the sidewall part 1051. The thickness after compression may represent the thickness of the gasket 1070 in a state after the gasket 1070 comes into contact with the end of the sidewall part 1051. The compression rate may refer to an average of the compression rates of the compressed points on the gasket 1070.

If the compression rate of one point of the gasket 1070 is less than 30%, the end of the sidewall part 1051 may not sufficiently press the gasket 1070. In this case, the end of the sidewall part 1051 may be damaged when not inserted into the gasket 1070 or bounced off the gasket 1070. For example, rust may be formed at the end of the sidewall part 1051. Accordingly, in an embodiment, the compression rate of one point of the gasket 1070 is 30% or more.

In addition, if the compression rate of one point of the gasket 1070 exceeds 90%, if the gasket 1070 is damaged, there may be a risk of contact between the end of the sidewall part 1051 and the cap assembly 1060. In this case, the cap assembly 1060 may be electrically connected to the case 1050. Therefore, in an embodiment, the compression rate of one point of the gasket 1070 is 90% or less.

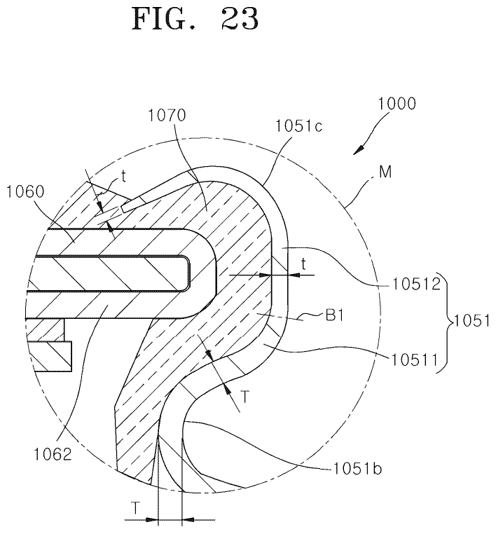

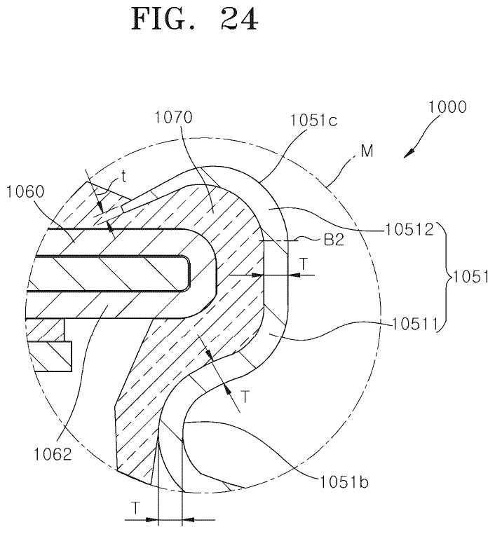

Referring to FIGS. 23 and 24, an example in which the beading part 1051b and the crimping part 1051c are formed in the first region 10511 or second region 10512, described in FIGS. 19 to 21, will be described.

FIG. 23 is an example of an enlarged view of a region “M” of FIG. 22. Referring to FIGS. 22 and 23, the sidewall part 1051 may include a bent part, which is a point where the beading part 1051b begins to form.

In FIG. 23, B1 represents a boundary between the first region 10511 and the second region 10512. For example, the boundary B1 may be located between the bent part and the end of the sidewall part 1051. For example, the boundary B1 may include a bent part. For example, the boundary B1 may be formed on the bent part. Accordingly, the weight of the secondary battery 1000 may be reduced.

Due to this structure, the beading part 1051b may be formed on the first region 10511. As the beading part 1051b is formed on the first region 10511, the beading part 1051b may be formed with the first thickness T. Accordingly, even when the beading part 1051b is formed in the sidewall part 1051, the strength of the region where the beading part 1051b is formed may not be reduced.

In addition, the crimping part 1051c may be formed on the second region 10512. As the crimping part 1051c is formed on the second region 10512, the crimping part 1051c may be formed with the second thickness t. Accordingly, the end of the sidewall part 1051 may be protected by the gasket 1070 while easily compressing the gasket 1070.

FIG. 24 is another example of an enlarged view of the region “M” of FIG. 22. Referring to FIG. 24, the sidewall part 1051 includes a crimping part 1051c formed by bending the end of the sidewall part 1051 toward the inside of the case 1050.

In FIG. 24, B2 represents a boundary between the first region 10511 and the second region 10512. For example, the boundary B2 may include the crimping part 1051c. For example, the boundary B2 may be located at the point where the crimping part 1051c begins to bend. Accordingly, the strength of the region located between the beading part 1051b and the crimping part 1051c at the sidewall part 1051 may be maintained.

Due to this structure, the beading part 1051b may be formed on the first region 10511. As the beading part 1051b is formed on the first region 10511, the beading part 1051b may be formed with the first thickness T. Accordingly, even when the beading part 1051b is formed in the sidewall part 1051, the strength of the region where the beading part 1051b is formed may not be reduced.

In addition, the crimping part 1051c may be formed on the second region 10512. As the crimping part 1051c is formed on the second region 10512, the crimping part 1051c may be formed with the second thickness t. Accordingly, the end of the sidewall part 1051 may be protected by the gasket 1070 while easily compressing the gasket 1070.

In FIGS. 22 to 24, an example where the first portion 105121 and the second portion 105122 are continuously formed without forming a step is described. However, embodiments of the present disclosure are not limited thereto, and the first portion 105121 and the second portion 105122 may form a step.

In addition, in FIGS. 22 to 24, a case where the second portion 105122 is continuously formed without forming a step, and becomes thinner toward the end of the sidewall part 1051 is described. However, embodiments of the present disclosure are not limited thereto, and the second portion 105122 may be formed with a uniform thickness, or may become thinner toward the end of the sidewall part 51 while forming a step.

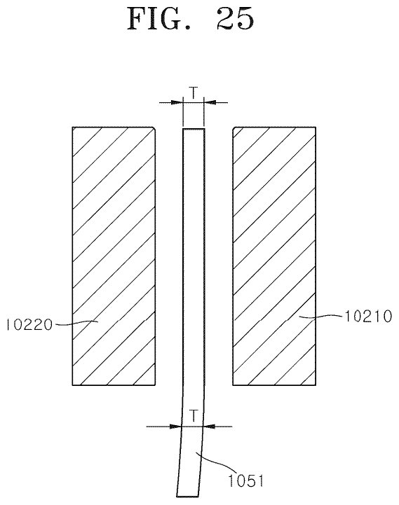

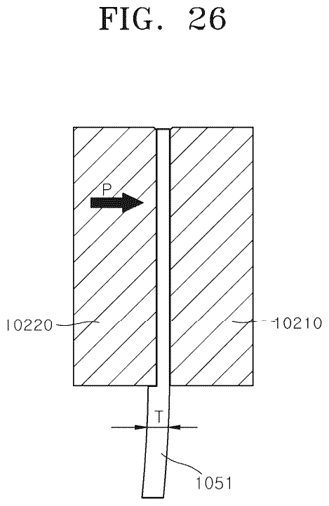

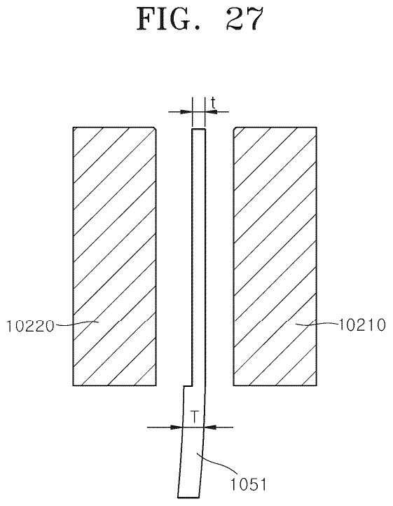

FIG. 25 is a view illustrating an example of a method of manufacturing a secondary battery according to an embodiment of the present disclosure. FIG. 26 is a view illustrating an example of a method of manufacturing a secondary battery according to an embodiment of the present disclosure. FIG. 27 is a view illustrating an example of a method of manufacturing a secondary battery according to an embodiment of the present disclosure.

Referring to FIGS. 25 to 27, the method of manufacturing a secondary battery includes forming a case 1050. The case 1050 includes a sidewall part 1051 formed with a first thickness T, a bottom part 1052 closing one end of the sidewall part 1051, and an opening formed in the other end of the sidewall part 1051. Here, the sidewall part 1051 may be formed with a uniform first thickness T as a whole.

In addition, the method of manufacturing a secondary battery includes pressing a region adjacent to the other end of the sidewall part 1051 such that the region has a second thickness t. A partial region of the sidewall part 1051 may be pressed by a die 10210 and a punch 10220. The partial region of the sidewall part 1051 may be a region relatively adjacent to the other end of the sidewall part 1051. The partial region of the sidewall part 1051 may include the other end of the sidewall part 1051. The partial region of the sidewall part 1051 may include the second region 10512 described in FIGS. 19 to 24.

For example, as shown in FIG. 25, the die 10210 may face the outer surface of the sidewall part 1051. In addition, the punch 10220 may face the inner surface of the sidewall part 1051.

For example, as shown in FIG. 26, the die 10210 may support the pressed sidewall part 1051 while contacting the outer surface of the sidewall part 1051. In addition, the punch 10220 may move toward the inner surface of the sidewall part 1051 in a P direction. For example, the punch 10220 may move toward the sidewall part 1051 and then press the sidewall part 1051.

For example, as shown in FIG. 27, the punch 10220 may press the sidewall part 1051 until a partial region of the sidewall part 1051 has the second thickness t. Here, the second thickness t is thinner than the first thickness T. When the partial region of the sidewall part 1051 is formed with the second thickness t, the die 10210 and/or the punch 10220 may be spaced apart from the sidewall part 1051.

The method of manufacturing a secondary battery may further include inserting an electrode assembly 1040 into the case 1050 through an opening. An electrolyte may be injected into the case 1050, and the electrode assembly 1040 may be impregnated with the electrolyte. In the method of manufacturing a secondary battery, the partial region of the sidewall part 1051 may be pressed after inserting the electrode assembly 1040 into the case 1050 through the opening.

In addition, the method of manufacturing a secondary battery may further include inserting the cap assembly 1060 on which a gasket 1070 is fitted into the opening.

In addition, the method of manufacturing a secondary battery may further include forming a crimping part 1051c in the partial region of the sidewall part 1051 formed with the second thickness t. For example, the end of the sidewall part 1051 may include the crimping part 1051c formed by bending toward the inside of the case 1050. As the crimping part 1051c is formed, the end of the sidewall part 1051 may be inserted into the gasket 1070 and buried.

In addition, the method of manufacturing a secondary battery may further include forming a beading part 1051b in another partial region of the sidewall part 1051 formed with the first thickness T. For example, the sidewall part 1051 may include a beading part 1051b formed concavely toward the inside of the case 1050. Here, the beading part 1051b and the crimping part 1051c may be formed concurrently (e.g., simultaneously), sequentially, or in reverse order.

According to the above-described method, the method of manufacturing a secondary battery according to an embodiment of the present invention may provide a technique for preventing or substantially preventing rust form forming on the case 1050 of a secondary battery.

The present invention has been described with reference to some embodiments illustrated in the drawings, but these are merely illustrative, and it is to be understood by those of ordinary skill in the art that various modifications and equivalent embodiments are possible therefrom.

Therefore, the scope of the present invention should be defined by the claims.

What is claimed is:

1. A secondary battery, comprising:
a case comprising an opening;
an electrode assembly accommodated in the case; and
a cap assembly facing the opening,
wherein the case comprises a crimping part that surrounds the cap assembly and comprises an exposure prevention part to prevent exposure of an end part of the crimping part.

2. The secondary battery as claimed in claim 1, wherein the exposure prevention part is configured such that the end part of the crimping part is bent toward an inside of the case.

3. The secondary battery as claimed in claim 2, further comprising a gasket arranged between the cap assembly and the crimping part, and sealing the case,
wherein the exposure prevention part is inclined downward into the case to press the gasket.

4. The secondary battery as claimed in claim 3, wherein the end part of the crimping part is thinner than a thickness of the crimping part.

5. The secondary battery as claimed in claim 2, further comprising a gasket arranged between the cap assembly and the crimping part, and sealing the case,
wherein the gasket comprises a sealing part sealing a space between the gasket and the exposure prevention part.

6. The secondary battery as claimed in claim 5, wherein the sealing part comprises a protrusion protruding from the gasket to come into contact with a bottom surface of the exposure prevention part, or an accommodation groove formed in the gasket to accommodate the exposure prevention part.

7. The secondary battery as claimed in claim 6, wherein the exposure prevention part is inclined downward into the case, and
the accommodation groove comprises an accommodation inclined surface contacting the bottom surface of the exposure prevention part, and an accommodation vertical surface extending vertically from an end of the accommodation inclined surface.

8. The secondary battery as claimed in claim 2, wherein the exposure prevention part is configured such that the end part of the crimping part is wound into a roll shape.

9. The secondary battery as claimed in claim 1, wherein the exposure prevention part is configured such that the end part of the crimping part is coated with a resin.

10. A secondary battery, comprising:
an electrode assembly; and
a case accommodating the electrode assembly, and comprising a sidewall part, a bottom part closing a first end of the sidewall part, and an opening at a second end of the sidewall part,
wherein the sidewall part comprises a first region comprising a beading part arranged concavely toward an inside and having a first thickness; and
a second region located adjacent to the second end and formed with a second thickness smaller than the first thickness.

11. The secondary battery as claimed in claim 10, wherein the sidewall part comprises a bent part at a location where the beading part begins, and
a boundary between the first region and the second region is located between the bent part and the second end of the sidewall part.

12. The secondary battery as claimed in claim 10, wherein the sidewall part comprises a crimping part formed by bending the second end of the sidewall part toward the inside of the case, and
the second region comprises the crimping part.

13. The secondary battery as claimed in claim 12, wherein a boundary between the first region and the second region is at a location where the bending of the crimping part begins.

14. The secondary battery as claimed in claim 10, wherein the second region has a uniform second thickness as a whole, or becomes thinner toward the second end of the sidewall part from a boundary with the first region.

15. The secondary battery as claimed in claim 10, wherein the second region comprises a first portion adjacent to the first region and having a third thickness, and a second portion adjacent to the second end and having a fourth thickness smaller than the third thickness.

16. The secondary battery as claimed in claim 15, wherein the second portion extends from the first portion with a step.

17. The secondary battery as claimed in claim 15, wherein the second region further comprises a third portion having a fifth thickness smaller than the third thickness and larger than the fourth thickness, and
the third portion is located between the first portion and the second portion, and has a step with at least one of the first portion and the second portion.

18. The secondary battery as claimed in claim 10, wherein the second region extends from the first region in a curved manner or extends from the first region with a step.

19. The secondary battery as claimed in claim 10, further comprising a cap assembly joined to the opening of the case to seal the case; and
a gasket arranged between the case and the cap assembly and comprising an insulating material,
wherein the second end of the sidewall part is bent toward an inside of the case to come into contact with the gasket.

20. A battery pack, comprising:
a housing;
a plurality of secondary batteries accommodated in the housing; and
a bus bar connecting the plurality of secondary batteries,
wherein the secondary batteries comprise the secondary battery of claim 1.
